(19) United States
(12) Patent Application Publication
(10) Pub. No.: US 2023/0292371 A1
(43) Pub. Date: Sep. 14, 2023

(54) RAR WINDOW DEFINITION IN NTN

(71) Applicant: Telefonaktiebolaget LM Ericsson (publ), Stockholm (SE)

(72) Inventors: Johan Rune, Lidingö (SE); Björn Hofström, Linköping (SE); Xingqin Lin, San Jose, CA (US)

(21) Appl. No.: 18/019,951

(22) PCT Filed: Aug. 6, 2021
(86) PCT No.: PCT/EP2021/072034

§ 371 Date: Feb. 6, 2023

Related U.S. Application Data
(60) Provisional application No. 63/062,153, filed on Aug. 6, 2020.

(51) Int. Cl. H04W 74/08; H04W 74/00

(52) U.S. Cl. CPC H04W 74/0833; H04W 74/006; H04W 84/06

(57) ABSTRACT

Systems and methods for defining a Random Access Response (RAR) window for a Non-Terrestrial Network (NTN) are provided. In some embodiments, a method performed by a User Equipment (UE) comprises transmitting a first random access transmission in a Physical Random Access Channel (PRACH) occasion, the first random access transmission being either a random access preamble or a Msg A; determining a reference symbol for a start of a response window, the response window being either a RAR window or a MsgB response window; and monitoring for a response during the response window, the start of the monitoring response window being defined relative to the reference symbol. In this way, some embodiments herein eliminate the problems associated with the current RAR window timing definition, when applied in an NTN.

### RELATED APPLICATIONS

This application claims the benefit of provisional patent application Ser. No. 63/062,153, filed Aug. 6, 2020, the disclosure of which is hereby incorporated herein by reference in its entirety.

### TECHNICAL FIELD

The present disclosure relates to propose Random Access Response (RAR) window definitions, which are designed for a system such as a Non-Terrestrial Network (NTN).

### BACKGROUND

I. Some General Properties of 5G/NR

An important property of the coming Fifth Generation (5G) System (5GS) (e.g., New Radio (NR)) is the usage of high carrier frequencies, e.g. in the range 24.25-52.6 GHz. For such high frequency spectrum, the atmospheric, penetration and diffraction attenuation properties can be much worse than for lower frequency spectrum. In addition, the receiver antenna aperture, as a metric describing the effective receiver antenna area that collects the electromagnetic energy from an incoming electromagnetic wave, is inversely proportional to the frequency, i.e., the link budget would be worse for the same link distance even in a free space scenario, if omnidirectional receive and transmit antennas are used. This motivates the usage of beamforming to compensate for the loss of link budget in high frequency spectrum. This is particularly important when communicating with User Equipments (UEs) with poor receivers, e.g. low cost/low complexity UEs. Other means for improving the link budget include repetition of the transmissions (e.g., to allow wide beam or omnidirectional transmission) or use of Single Frequency Network transmission from multiple Transmission/Reception Points (TRPs) in the same or different cells.

Due to the above described properties, in the high frequency bands, many downlink signals, such as Synchronization Signals (SS), System Information (SI), and paging, which need to cover a certain area (i.e. not just targeting a single UE with known location/direction), e.g. a cell, are expected to be transmitted using beam sweeping, i.e. transmitting the signal in one beam at a time, sequentially changing the direction and coverage area of the beam until the entire intended coverage area, e.g. the cell, has been covered by the transmission. Also in lower carrier frequencies, e.g. ranging from below 3 GHz to 6 GHz, beamforming is envisioned to be used in NR to improve coverage, albeit with fewer and wider beams (compared to higher frequencies) to cover a cell area.

The signals and channels in NR which correspond to the Primary Synchronization Signal (PSS), Secondary Synchronization Signal (SSS), Cell specific Reference Signal (CRS) and Public Broadcast Channel (PBCH) (which carries the Master Information Block (MIB) and layer 1 generated bits) in Long Term Evolution (LTE), i.e. PSS, SSS, DeModulation Reference Signal (DMRS) for PBCH and PBCH (sometimes referred to as NR-PSS, NR-SSS, DMRS for NR-PBCH and NR-PBCH in NR) are put together in an entity/structure denoted SS Block (SSB) or, with other terminology, SS/PBCH block (the term SS Block is typically used in Radio Access Network (RAN) 2 while RAN1 usually uses the term SS/PBCH block). RAN1, RAN2, RAN3 and RAN4 are Third Generation Partnership Project (3GPP) working groups, more formally referred to as Technical Specification Group Radio Access Network (TSG-RAN) WG1, TSG-RAN WG2, TSG-RAN WG3 and TSG-RAN WG4. Hence, SS Block, SSB, and SS/PBCH block are three synonyms (although SSB is really an abbreviation of SS Block). SSBs are typically beamformed and multiple SSBs transmissions are required to cover a cell. Such a set of SSB transmissions used to cover a cell (typically in the form of a so called beam sweep) are referred to as an SS Burst and each SSB in the SS Burst is associated with a unique SSB index.

The PSS+SSS enables a UE to synchronize with the cell and also carries information from which the Physical Cell Identity (PCI) can be derived. The PBCH part (including DMRS) of the SSB carries a part of the SI denoted MIB or New Radio Master Information Block (NR-MIB), 8 layer-one generated bits and the SSB index within the SS Burst. In high frequencies, SS Blocks will be transmitted periodically via a same beam but also being swept over a number of beams (the latter comprising an SS burst). As mentioned above, multiple such beamformed SS Block transmissions are grouped into an SS Burst which constitutes a full beam sweep of SS Block transmissions. When many beams are used, longer gaps, e.g. 2 or 4 slots (where each slot contains 14 Orthogonal Frequency-Division Multiplexing (OFDM) symbols) are inserted into the beam sweep. This effectively creates groups of SS Block transmissions within the SS Burst.

In NR, the SI is divided into the two main parts “Minimum SI” (MSI) and “Other SI” (OSI). The MSI is always periodically broadcast, whereas the OSI may be periodically broadcast or may be available on-demand (and different parts of the OSI may be treated differently). The MSI consists of the MIB and System Information Block type 1 (SIB1), where SIB1 is also referred to as Remaining Minimum System Information (RMSI) (the term SIB1 is typically used by RAN2 while RAN1 usually uses the term RMSI). SIB1/RMSI is periodically broadcast using a Physical Downlink Control Channel (PDCCH)/Physical Downlink Shared Channel (PDSCH)-like channel structure, i.e. with a scheduling allocation transmitted on the PDCCH (or NR-PDCCH), allocating transmission resources on the PDSCH (or NR-PDSCH), where the actual RMSI is transmitted. The MIB contains information that allows a UE to find and decode RMSI/SIB1. More specifically, configuration parameters for the PDCCH utilized for the RMSI/SIB1 is provided in the MIB (when an associated RMSI/SIB1 exists), in the form of CORESET and search space. A further 3GPP agreement for release 15 concerning RMSI transmission is that the RMSI/SIB1 transmissions should be spatially Quasi Co-Located (QCL) with the SS Block transmissions. A consequence of the QCL property is that the PSS/SSS transmission can be relied on for accurate synchronization and beam selection to be used when receiving the PDCCH/PDSCH carrying the RMSI/SIB1. The same QCL assumption is valid for paging.

Just like in LTE, paging and OSI in NR are transmitted using the PDCCH+PDSCH principle with PDSCH downlink (DL) scheduling allocation on the PDCCH and Radio Resource Control (RRC) Paging message or SI message on the PDSCH. An exception to this is that when paging is used to notify UEs of Earthquake and Tsunami Warning System (ETWS), Commercial Mobile Alert System (CMAS) or SI updates, the information is conveyed in the paging DCI on the PDCCH (referred to as “Short Message”), thus skipping the RRC Paging message on the PDSCH.

It may also be relevant to describe a difference in the time domain structure of L1 of the radio interface between LTE and NR. While LTE always has the same structure, NR has different structures, because it comprises different so-called numerologies (which essentially can be translated to different Subcarrier Spacings (SCSs) and consequent differences in the time domain, e.g. the length of an OFDM symbol). In LTE, the L1 radio interface time domain structure consists of symbols, subframes and radio frames, where a 1 ms subframe consists of 14 symbols (12 if extended cyclic prefix is used) and 10 subframes form a 10 ms radio frame. In NR, the concepts of subframes and radio frames are reused in the sense that they represent the same time periods, i.e. 1 ms and 10 ms respectively, but their internal structures vary depending on the numerology. For this reason, the additional term “slot” is introduced in NR, which is a time domain structure that always contains 14 symbols (for normal cyclic prefix), irrespective of the symbol length. Note that the choice of the term “slot” to refer to a set of 14 OFDM symbols in NR is somewhat unfortunate, since the term “slot” also exists in LTE, although in LTE it refers to half a subframe, i.e. 0.5 ms containing 7 OFDM symbols (or 6 OFDM symbols in when extended cyclic prefix is used). Hence, the number of slots and symbols comprised in a subframe and a radio frame vary with the numerology, but the number of symbols in a slot remains consistent. The numerologies and parameters are chosen such that a subframe always contains an integer number of slots (i.e., no partial slots). More details about the physical layer structure follow below.

Downlink transmissions are dynamically scheduled, i.e., the New Radio Base Station (gNB) transmits Downlink Control Information (DCI) about which UE data is to be transmitted to and which resource blocks in the current downlink slot the data is transmitted on. This control information is typically transmitted in the first one or two OFDM symbols in each slot in NR. The control information is carried on the PDCCH and data is carried on the PDSCH. A UE first detects and decodes PDCCH and if a PDCCH is decoded successfully, it then decodes the corresponding PDSCH based on the decoded control information in the PDCCH.

In addition to PDCCH and PDSCH, there are also other channels and reference signals transmitted in the downlink.

Uplink data transmissions, carried on Physical Uplink Shared Channel (PUSCH), are also dynamically scheduled by the gNB by transmitting a DCI. In case of Time Division Duplexing (TDD) operation, the DCI (which is transmitted in the DL region) always indicates a scheduling offset so that the PUSCH is transmitted in a slot in the uplink (UL) region.

II. Random Access Channel (RACH) Configurations in NR

In NR, the Random Access (RA) procedure is described in the NR Medium Access Control (MAC) specifications and parameters are configured by RRC e.g. in SI or handover (RRCReconfiguration with reconfigurationWithSync). Random access is triggered in many different scenarios, for example, when the UE is in RRC_IDLE or RRC_INACTIVE and wants to access a cell that it is camping on (i.e., transition to RRC_CONNECTED).

In NR, RACH configuration is broadcasted in SIB1, as part of the servingCellConfigCommon IE. In addition, RACH configuration can be conveyed to the UE in dedicated RRC signaling. This is e.g. the case when contention-free random access is configured in conjunction with handover.

Inherited from LTE, a 4-step RA procedure was specified for NR in 3GPP release 15. In release 16, an alternative RA procedure, denoted 2-step RA has been specified, which can be used in parallel with the 4-step RA procedure.

The following RRC information elements (extracted from 3GPP TS 38.331 version 16.1.0) are relevant for 4-step and 2-step random access configuration.

RACH-ConfigGeneric information element

-- ASN1START
-- TAG-RACH-CONFIGGENERIC-START

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |
| msg1-FrequencyStart | INTEGER (0..maxNrofPhysicalResourceBlocks−1), |
| zeroCorrelationZoneConfig | INTEGER(0..15), |
| preambleReceivedTargetPower | INTEGER (−202..−60), |
| preambleTransMax | ENUMERATED {n3, n4, n5, n6, n7, n8, n10, n20, n50, n100, n200}, |
| powerRampingStep | ENUMERATED {dB0, dB2, dB4, dB6}, |
| ra-ResponseWindow | ENUMERATED {sl1, s12, sl4, sl8, sl10, sl20, sl40, sl80}, |

```
  ...,
  [[
```

| | |
|---|---|
| prach-ConfigurationPeriodScaling-IAB-r16 | ENUMERATED {scf1,scf2,scf4,scf8,scf16,scf32,scf64} |

OPTIONAL, -- Need R

| | |
|---|---|
| prach-ConfigurationFrameOffset-IAB-r16 | INTEGER (0..63) |

OPTIONAL, -- Need R

| | |
|---|---|
| prach-ConfigurationSOffset-IAB-r16 | INTEGER (0..39) |

OPTIONAL, -- Need R

| | |
|---|---|
| ra-ResponseWindow-v1610 | ENUMERATED { sl60, sl160} |

OPTIONAL, -- Need R

| | |
|---|---|
| prach-ConfigurationIndex-v1610 | INTEGER (256..262) |

OPTIONAL -- Need R
]]
}
-- TAG-RACH-CONFIGGENERIC-STOP
-- ASN1STOP

RACH-ConfigGeneric field descriptions

msg1-FDM
The number of PRACH transmission occasions FDMed in one time instance. (see TS 38.211 [16],
clause 6.3.3.2).
msg1-FrequencyStart
Offset of lowest PRACH transmission occasion in frequency domain with respective to PRB 0. The
value is configured so that the corresponding RACH resource is entirely within the bandwidth of the UL
BWP. (see TS 38.211 [16], clause 6.3.3.2).
powerRampingStep
Power ramping steps for PRACH (see TS 38.321 [3], 5.1.3).
prach-ConfigurationFrameOffset-IAB
Scaling factor for ROs defined in the baseline configuration indicated by prach-ConfigurationIndex and
is used only by the IAB-MT. (see TS 38.211 [16], clause 6.3.3.2).
prach-ConfigurationIndex
PRACH configuration index. For prach-ConfigurationIndex configured under beamFailureRecovery-
Config, the prach-ConfigurationIndex can only correspond to the short preamble format, (see TS
38.211 [16], clause 6.3.3.2). If the field prach-ConfigurationIndex-v1610 is present, the UE shall ignore
the value provided in prach-ConfigurationIndex (without suffix).
prach-ConfigurationPeriodScaling-IAB
Scaling factor to extend the periodicity of the baseline configuration indicated by prach-
ConfigurationIndex and is used only by the IAB-MT. Value scf1 corresponds to scaling factor of 1 and
so on. (see TS 38.211 [16], clause 6.3.3.2).
prach-ConfigurationSOffset-IAB
Subframe/Slot offset for ROs defined in the baseline configuration indicated by prach-
ConfigurationIndex and is used only by the IAB-MT. (see TS 38.211 [16], clause 6.3.3.2).
preambleReceivedTargetPower
The target power level at the network receiver side (see TS 38.213 [13], clause 7.4, TS 38.321 [3],
clauses 5.1.2, 5.1.3). Only multiples of 2 dBm may be chosen (e.g. −202, −200, −198, . . .).
preamble TransMax
Max number of RA preamble transmission performed before declaring a failure (see TS 38.321 [3],
clauses 5.1.4, 5.1.5).
ra-ResponseWindow
Msg2 (RAR) window length in number of slots. The network configures a value lower than or equal to
10 ms when Msg2 is transmitted in licensed spectrum and 40 ms when Msg2 is transmitted with
shared spectrum channel access (see TS 38.321 [3], clause 5.1.4). UE ignores the field if included in
SCellConfig. If ra-ResponseWindow-v1610 is signaled, UE shall ignore the ra-ResponseWindow
(without suffix). For operation with shared spectrum channel access and when ra-ResponseWindow
value is more than 10 ms, the network always includes the two LSB bits of the SFN corresponding to
the PRACH occasion where the preamble is received in the DCI scheduling Msg2 (see TS 38.213
[13]).
zeroCorrelationZoneConfig
N-CS configuration, see Table 6.3.3.1-5 in TS 38.211 [16].

RACH-ConfigGenericTwoStepRA information element

-- ASN1START
-- TAG-RACH-CONFIGGENERICTWOSTEPRA-START

| RACH-ConfigGenericTwoStepRA-r16 ::= | SEQUENCE { | |
|---|---|---|
| msgA-PRACH-ConfigurationIndex-r16 | INTEGER (0..262) | OPTIONAL, - |

- Cond 2StepOnly

| | | |
|---|---|---|
| msgA-RO-FDM-r16 | ENUMERATED {one, two, four, eight} | OPTIONAL, |

-- Cond 2StepOnly

| | |
|---|---|
| msgA-RO-FrequencyStart-r16 | INTEGER (0..maxNrofPhysicalResourceBlocks−1) |

OPTIONAL, -- Cond 2StepOnly

| | | |
|---|---|---|
| msgA-ZeroCorrelationZoneConfig-r16 | INTEGER (0..15) | OPTIONAL, -- |

Cond 2StepOnly

| | |
|---|---|
| msgA-PreamblePowerRampingStep-r16 | ENUMERATED {dB0, dB2, dB4, dB6} |

OPTIONAL, -- Cond 2StepOnlyNoCFRA

| | |
|---|---|
| msgA-PreambleReceivedTargetPower-r16 | INTEGER (−202..−60) |

OPTIONAL, -- Cond 2StepOnlyNoCFRA

| | |
|---|---|
| msgB-ResponseWindow-r16 | ENUMERATED {sl1, sl2, sl4, sl8, sl10, sl20, sl40, sl80, sl160, |

sl320}

OPTIONAL, -- Cond NoCFRA

| | |
|---|---|
| preambleTransMax-r16 | ENUMERATED {n3, n4, n5, n6, n7, n8, n10, n20, n50, n100, n200} |

OPTIONAL, -- Cond 2StepOnlyNoCFRA
...
}
-- TAG-RACH-CONFIGGENERICTWOSTEPRA-STOP
-- ASN1STOP

RACH-ConfigGenericTwoStepRA field descriptions

msgA-PreamblePowerRamping Step
Power ramping steps for msgA PRACH. If the field is absent, UE shall use the value of
powerRampingStep in RACH-ConfigGeneric in the configured BWP (see TS 38.321 [3], 5.1.3). This
field may only be present if no 4-step type RA is configured in the BWP or in the case of separate ROs
with 4-step type RA. The field is absent if RACH-ConfigGenericTwoStepRA is included in CFRA-
TwoStep in RACH-ConfigDedicated and then the UE uses the value of msgA-
PreamblePowerRampingStep in RACH-ConfigGenericTwoStepRA configured for CBRA.
msgA-PreambleReceivedTargetPower
The target power level at the network receiver side (see TS 38.213 [13], clause 7.1.1 and TS 38.321
[3], clause 5.1.1). Only multiples of 2 dBm may be chosen (e.g. −202, −200, −198, . . .). If the field is
absent, UE shall use the value of preambleReceivedTargetPower in RACH-ConfigGeneric in the
configured BWP. This field may only be present if no 4-step type RA is configured in the BWP. The
field is absent if RACH-ConfigGenericTwoStepRA is included in CFRA-TwoStep in RACH-
ConfigDedicated and then the UE uses the value of msgA-PreambleReceivedTargetPower in RACH-
ConfigGenericTwoStepRA configured for CBRA.
msgA-PRACH-ConfigurationIndex
Cell-specific PRACH configuration index for 2-step RA type. If the field is absent the UE shall use the
value of corresponding 4-step random access parameter in the configured BWP. If the value is in the
range of 256 to 262, the field prach-ConfigurationIndex-v1610 should be considered configured (see
TS 38.211 [16], clause 6.3.3.2). This field may only be present if no 4-step type RA is configured in the
BWP or in the case of separate ROs with 4-step type RA.
msgA-RO-FDM
The number of msgA PRACH transmission occasions Frequency-Division Multiplexed in one time
instance. If the field is absent, UE shall use value of msg1-FDM in RACH-ConfigGeneric in the
configured BWP (see TS 38.211 [16], clause 6.3.3.2). This field may only be present if no 4-step type
RA is configured in the BWP or in the case of separate ROs with 4-step type RA.
msgA-RO-FrequencyStart
Offset of lowest PRACH transmissions occasion in frequency domain with respect to PRB 0. If the
field is absent, UE shall use value of msg1-FrequencyStart in RACH-ConfigGeneric in the configured
BWP (see TS 38.211 [16], clauses 5.3.2 and 6.3.3.2). This field may only be present if no 4-step type
RA is configured in the BWP or in the case of separate ROs with 4-step type RA.
msgA-ZeroCorrelationZoneConfig
N-CS configuration for msgA preamble, see Table 6.3.3.1-5 in TS 38.211 [16]. If the field is absent,
UE shall use value zeroCorrelationZoneConfig in RACH-ConfigGeneric in the configured BWP. This
field may only be present if no 4-step type RA is configured in the BWP or in the case of separate ROs
with 4-step type RA.
msgB-ResponseWindow
MsgB monitoring window length in number of slots. The network configures a value lower than or
equal to 40ms (see TS 38.321 [3], clause 5.1.1). If the field is absent, the UE use the value of msgB-
ResponseWindow in RACH-ConfigGenericTwoStepRA configured for CBRA.
preamble Trans Max
Max number of RA preamble transmission performed before declaring a failure (see TS 38.321 [3],
clauses 5.1.4, 5.1.5). If the field is absent, UE shall use the value of preamble TransMax in RACH-
ConfigGeneric in the configured BWP. The field is absent if RACH-ConfigGenericTwoStepRA is
included in CFRA-TwoStep in RACH-ConfigDedicated and then the UE uses the value of
preamble TransMax in RACH-ConfigGenericTwoStepRA configured for CBRA.

| Conditional Presence | Explanation |
|---|---|
| 2StepOnly | The field is mandatory present if there are no 4-step random access |
| | configurations configured in the BWP, i.e. only 2-step random access type |
| | configured in the BWP, otherwise the field is Need S |
| 2StepOnlyNoCFRA | The field is mandatory present if RACH-ConfigGenericTwoStepRA is |
| | included in the RACH-ConfigCommon TwoStepRA and there are no 4-step |
| | random access configurations configured in the BWP (i.e. only 2-step |
| | random access type configured in the BWP), otherwise (i.e. 4-step |
| | random access configuration also exists in the BWP) the field is optional, |
| | Need S. When RACH-ConfigGenericTwoStepRA is included in the RACH- |
| | ConfigDedicated, this field is absent. |
| NoCFRA | The field is mandatory present if RACH-ConfigGenericTwoStepRA is not |
| | included in CFRA-TwoStep in RACH-ConfigDedicated, otherwise the field |
| | is absent, Need S. |

RA-Prioritization information element

-- ASN1START
-- TAG-RA-PRIORITIZATION-START

| RA-Prioritization ::= | SEQUENCE { | |
|---|---|---|
| powerRampingStepHighPriority | ENUMERATED {dB0, dB2, dB4, dB6}, | |
| scalingFactorBI | ENUMERATED {zero, dot25, dot5, dot75} | OPTIONAL, -- |

Need R
...
}
-- TAG-RA-PRIORITIZATION-STOP
-- ASN1STOP

RA-Prioritization field descriptions

powerRamping StepHighPrioritiy
Power ramping step applied for prioritized random access procedure.
scaling FactorBI
Scaling factor for the backoff indicator (BI) for the prioritized random access procedure. (see TS
38.321 [3], clause 5.1.4). Value zero corresponds to 0, value dot25 corresponds to 0.25 and so on.

RACH-ConfigCommon information element

-- ASN1START
-- TAG-RACH-CONFIGCOMMON-START

| RACH-Config Common ::= | SEQUENCE { | |
|---|---|---|
| rach-Config Generic | RACH-ConfigGeneric, | |
| totalNumberOfRA-Preambles | INTEGER (1..63) | OPTIONAL, -- |

Need S

| | |
|---|---|
| ssb-perRACH-OccasionAndCB-PreamblesPerSSB | CHOICE { |
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

| | |
|---|---|
| } | OPTIONAL, -- Need M |

| | |
|---|---|
| groupBconfigured | SEQUENCE { |
| ra-Msg3SizeGroupA | ENUMERATED {b56, b144, b208, b256, b282, b480, b640, |
| | b800, b1000, b72, spare6, spare5,spare4, spare3, spare2, spare1}, |
| messagePowerOffsetGroupB | ENUMERATED { minusinfinity, dB0, dB5, dB8, dB10, dB12, |

dB15, dB18},

| numberOfRA-PreamblesGroupA | INTEGER (1..64) | |
|---|---|---|
| } | | OPTIONAL, -- Need R |
| ra-ContentionResolutionTimer | ENUMERATED { sf8, sf16, sf24, sf32, sf40, sf48, sf56, sf64}, | |
| rsrp-ThresholdSSB | RSRP-Range | OPTIONAL, -- Need R |
| rsrp-ThresholdSSB-SUL | RSRP-Range | OPTIONAL, -- |

Cond SUL

| | |
|---|---|
| prach-RootSequenceIndex | CHOICE { |
| I839 | INTEGER (0..837), |
| I139 | INTEGER (0.137) |

},

| | | |
|---|---|---|
| msg1-SubcarrierSpacing | SubcarrierSpacing | OPTIONAL, -- |

Cond L139

| | |
|---|---|
| restrictedSetConfig | ENUMERATED {unrestrictedSet, restrictedSetTypeA, |

restrictedSetTypeB},

| | | |
|---|---|---|
| msg3-transformPrecoder | ENUMERATED {enabled} | OPTIONAL, - |

```
- Need R
  ...,
  [[
```

| | |
|---|---|
| ra-PrioritizationForAccessIdentity | SEQUENCE { |
| ra-Prioritization-r16 | RA-Prioritization, |
| ra-PrioritizationForAI-r16 | BIT STRING (SIZE (2)) |

| | |
|---|---|
| } | OPTIONAL, -- Cond InitialBWP-Only |

| | |
|---|---|
| prach-RootSequenceIndex-r16 | CHOICE { |
| I571 | INTEGER (0..569), |
| I1151 | INTEGER (0..1149) |

```
  } OPTIONAL - Need R
  ]]
}
-- TAG-RACH-CONFIGCOMMON-STOP
-- ASN1STOP
```

RACH-ConfigCommon field descriptions

messagePowerOffsetGroupB
Threshold for preamble selection. Value is in dB. Value minusinfinity corresponds to -infinity. Value
dBO corresponds to 0 dB, dB5 corresponds to 5 dB and so on. (see TS 38.321 [3], clause 5.1.2)
msg1-SubcarrierSpacing
Subcarrier spacing of PRACH (see TS 38.211 [16], clause 5.3.2). Only the values 15 or 30 kHz (FR1),
and 60 or 120 kHz (FR2) are applicable. If absent, the UE applies the SCS as derived from the prach-
ConfigurationIndex in RACH-ConfigGeneric (see tables Table 6.3.3.1-1 and Table 6.3.3.2-2, TS
38.211 [16]). The value also applies to contention free random access (RACH-ConfigDedicated), to
SI-request and to contention-based beam failure recovery (CB-BFR). But it does not apply for
contention free beam failure recovery (CF-BFR) (see BeamFailureRecoveryConfig).
msg3-transformPrecoder
Enables the transform precoder for Msg3 transmission according to clause 6.1.3 of TS 38.214 [19]. If
the field is absent, the UE disables the transformer precoder (see TS 38.213 [13], clause 8.3).
numberOfRA-PreamblesGroupA
The number of CB preambles per SSB in group A. This determines implicitly the number of CB
preambles per SSB available in group B. (see TS 38.321 [3], clause 5.1.1). The setting should be
consistent with the setting of ssb-perRACH-OccasionAndCB-PreamblesPerSSB.
prach-RootSequenceIndex
PRACH root sequence index (see TS 38.211 [16], clause 6.3.3.1). The value range depends on
whether L = 839 or L = 139. The short/long preamble format indicated in this IE should be consistent
with the one indicated in prach-ConfigurationIndex in the RACH-ConfigDedicated (if configured). If
prach-RootSequenceIndex-r16 is signaled, UE shall ignore the prach-RootSequenceIndex (without
suffix).
ra-ContentionResolution Timer
The initial value for the contention resolution timer (see TS 38.321 [3], clause 5.1.5). Value sf8
corresponds to 8 subframes, value sf16 corresponds to 16 subframes, and so on.
ra-Msg3SizeGroupA
Transport Blocks size threshold in bits below which the UE shall use a contention-based RA preamble
of group A. (see TS 38.321 [3], clause 5.1.2).
ra-PrioritizationForAl
Indicates whether the field ra-Prioritization-r16 applies for Access Identities. The first/leftmost bit
corresponds to Access Identity 1, the next bit corresponds to Access Identity 2. Value 1 indicates that
the field ra-Prioritization-r16 applies otherwise the field does not apply (see TS 23.501 [32]).
ra-Prioritization
Parameters which apply for prioritized random access procedure on any UL BWP of SpCell for
specific Access Identities (see TS 38.321 [3], clause 5.1.1a).
rach-ConfigGeneric
RACH parameters for both regular random access and beam failure recovery.
restrictedSetConfig
Configuration of an unrestricted set or one of two types of restricted sets, see TS 38.211 [16], clause
6.3.3.1.
rsrp-ThresholdSSB
UE may select the SS block and corresponding PRACH resource for path-loss estimation and
(re)transmission based on SS blocks that satisfy the threshold (see TS 38.213 [13]).
rsrp-ThresholdSSB-SUL
The UE selects SUL carrier to perform random access based on this threshold (see TS 38.321 [3],
clause 5.1.1). The value applies to all the BWPs.
ssb-perRACH-OccasionAndCB-PreamblesPerSSB
The meaning of this field is twofold: the CHOICE conveys the information about the number of SSBs
per RACH occasion. Value oneEighth corresponds to one SSB associated with 8 RACH occasions,
value oneFourth corresponds to one SSB associated with 4 RACH occasions, and so on. The
ENUMERATED part indicates the number of Contention Based preambles per SSB. Value n4
corresponds to 4 Contention Based preambles per SSB, value n8 corresponds to 8 Contention Based
preambles per SSB, and so on. The total number of CB preambles in a RACH occasion is given by
CB-preambles-per-SSB * max(1, SSB-per-rach-occasion). See TS 38.213 [13].
totalNumberOfRA-Preambles
Total number of preambles used for contention based and contention free 4-step or 2-step random
access in the RACH resources defined in RACH-ConfigCommon, excluding preambles used for other
purposes (e.g. for SI request). If the field is absent, all 64 preambles are available for RA. The setting
should be consistent with the setting of ssb-perRACH-OccasionAndCB-PreamblesPerSSB, i.e. it
should be a multiple of the number of SSBs per RACH occasion.

| Conditional | |
|---|---|
| Presence | Explanation |
| L139 | The field is mandatory present if prach- |
| | RootSequenceIndex L = 139, otherwise the field is |
| | absent, Need S. |
| SUL | The field is mandatory present in initialUplinkBWP in |
| | supplementaryUplink; otherwise, the field is absent. |
| InitialBWP- | This field is optionally present, Need R, if this BWP is |
| Only | the initial BWP of SpCell. Otherwise the field is absent. |

RACH-ConfigCommonTwoStepRA information element

-- ASN1START
-- TAG-RACH-CONFIGCOMMONTWOSTEPRA-START

| RACH-ConfigCommonTwoStepRA-r16 ::= | SEQUENCE { | |
|---|---|---|
| rach-Config Generic TwoStepRA-r16 | RACH-ConfigGeneric TwoStepRA-r16, | |
| msgA-TotalNumberOfRA-Preambles-r16 | INTEGER (1..63) | OPTIONAL, |

-- Need S

| | |
|---|---|
| msgA-SSB-PerRACH-OccasionAndCB-PreamblesPerSSB-r16 | CHOICE { |
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

| | |
|---|---|
| } | OPTIONAL, -- Cond 2StepOnly |

| | |
|---|---|
| msgA-CB-PreamblesPerSSB-PerSharedRO-r16 | INTEGER (1..60) |

OPTIONAL, -- Cond SharedRO

| | |
|---|---|
| msgA-SSB-SharedRO-MaskIndex-r16 | INTEGER (1..15) |

OPTIONAL, -- Need S

| | |
|---|---|
| groupB-ConfiguredTwoStepRA-r16 | GroupB-ConfiguredTwoStepRA-r16 |

OPTIONAL, -- Need S

| | |
|---|---|
| msgA-PRACH-RootSequenceIndex-r16 | CHOICE { |
| I839 | INTEGER (0 ..837), |
| I139 | INTEGER (0 ..137), |
| I571 | INTEGER (0..569), |
| I1151 | INTEGER (0..1149) |

| | |
|---|---|
| } | OPTIONAL, -- Cond 2StepOnly |

| | |
|---|---|
| msgA-TransMax-r16 | ENUMERATED {n1, n2, n4, n6, n8, n10, n20, n50, n100, |
| n200} OPTIONAL, -- Need R | RSRP-Range |

msgA-RSRP-Threshold-r16

| | |
|---|---|
| OPTIONAL, -- Cond 2Step4Step | RSRP-Range |

msgA-RSRP-ThresholdSSB-r16

| | |
|---|---|
| OPTIONAL, -- Need R | SubcarrierSpacing |

msgA-SubcarrierSpacing-r16
OPTIONAL, -- Cond 2StepOnlyL139

| msgA-RestrictedSetConfig-r16 | ENUMERATED {unrestrictedSet, restrictedSetTypeA, | |
|---|---|---|
| | restrictedSetTypeB} | OPTIONAL, -- Cond |

2StepOnly

| | |
|---|---|
| ra-PrioritizationForAccessIdentityTwoStep-r16 | SEQUENCE { |
| ra-Prioritization-r16 | RA-Prioritization, |
| ra-PrioritizationForAI-r16 | BIT STRING (SIZE (2)) |

| | |
|---|---|
| } | OPTIONAL, -- Cond InitialBWP- |

Only

| | |
|---|---|
| ra-ContentionResolutionTimer-r16 | ENUMERATED {sf8, sf16, sf24, sf32, sf40, sf48, sf56, |

sf64} OPTIONAL, -- Cond 2StepOnly
...
}

| | |
|---|---|
| GroupB-ConfiguredTwoStepRA-r16 ::= | SEQUENCE { |
| ra-MsgA-SizeGroupA | ENUMERATED {b56, b144, b208, b256, b282, b480, b640, |

b800,

| | |
|---|---|
| | b1000, b72, spare6, spare5, spare4, spare3, spare2, spare1}, |
| messagePowerOffsetGroupB | ENUMERATED {minusinfinity, dB0, dB5, dB8, dB10, |

dB12, dB15, dB18},

| | |
|---|---|
| numberofRA-PreamblesGroupA | INTEGER (1..64) |

}
-- TAG-RACH-CONFIGCOMMONTWOSTEPRA-STOP
-- ASN1STOP

RACH-ConfigCommon TwoStepRA field descriptions

groupB-ConfiguredTwoStepRA
Preamble grouping for 2-step random access type. If the field is absent then there is only one
preamble group configured and only one msgA PUSCH configuration.
msgA-CB-PreamblesPerSSB-PerSharedRO
Number of contention-based preambles used for 2-step RA type from the non-CBRA 4-step type
preambles associated with each SSB for RO shared with 4-step type RA. The number of preambles
for 2-step RA type shall not exceed the number of preambles per SSB minus the number of
contention-based preambles per SSB for 4-step type RA. The possible value range for this parameter
needs to be aligned with value range for the configured SSBs per RACH occasion in SSB-perRACH-
OccasionAndCB-PreamblesPerSSB in RACH-ConfigCommon. The field is only applicable for the case
of shared ROs with 4-step type random access.
msgA-PRACH-RootSequenceIndex
PRACH root sequence index. If the field is not configured, the UE applies the value in field prach-
RootSequenceIndex in RACH-ConfigCommon in the configured BWP. When both 2-step and 4-step
type random access is configured, this field is only configured for the case of separate ROs between
2-step and 4-step type random access.
msgA-RestrictedSetConfig
Configuration of an unrestricted set or one of two types of restricted sets for 2-step random access
type preamble. If the field is not configured, the UE applies the value in field restrictedSetConfig in
RACH-ConfigCommon in the configured BWP. When both 2-step and 4-step type random access is
configured, this field is only configured for the case of separate ROs between 2-step and 4-step type
random access.
msgA-RSRP-Threshold
The UE selects 2-step random access type to perform random access based on this threshold (see
TS 38.321 [3], clause 5.1.1). This field is only present if both 2-step and 4-step RA type are configured
for the BWP.
msgA-RSRP-ThresholdSSB
UE may select the SS block and corresponding PRACH resource for path-loss estimation and
(re)transmission based on SS blocks that satisfy the threshold (see TS 38.213 [13]).
msgA-SSB-PerRACH-OccasionAndCB-PreamblesPerSSB
The meaning of this field is twofold: the CHOICE conveys the information about the number of SSBs
per RACH occasion. Value oneEight corresponds to one SSB associated with 8 RACH occasions,
value oneFourth corresponds to one SSB associated with 4 RACH occasions, and so on. The
ENUMERATED part indicates the number of Contention Based preambles per SSB. Value n4
corresponds to 4 Contention Based preambles per SSB, value n8 corresponds to 8 Contention Based
preambles per SSB, and so on. The total number of CB preambles in a RACH occasion is given by
CB-preambles-per-SSB * max(1, SSB-per-rach-occasion). If the field is not configured and both 2-step
and 4-step are configured for the BWP, the UE applies the value in the field ssb-perRACH-
OccasionAndCB-PreamblesPerSSB in RACH-ConfigCommon. The field is not present when RACH
occasions are shared between 2-step and 4-step type random access in the BWP.
msgA-SSB-SharedRO-MaskIndex
Indicates the subset of 4-step type ROs shared with 2-step random access type for each SSB. This
field is configured when there is more than one RO per SSB. If the field is absent, and 4-step and 2-
step has shared ROs, then all ROs are shared.
msgA-SubcarrierSpacing
Subcarrier spacing of PRACH (see TS 38.211 [16], clause 5.3.2). Only the values 15 or 30 kHz (FR1),
and 60 or 120 kHz (FR2) are applicable. The field is only present in case of 2-step only BWP,
otherwise the UE applies the SCS as derived from the msg1-SubcarrierSpacing in RACH-
ConfigCommon. The value also applies to contention free 2-step random access type (RACH-
ConfigDedicated).
msgA-TotalNumberOfRA-Preambles
Indicates the total number of preambles used for contention-based and contention-free 2-step random
access type when ROs for 2-step are not shared with 4-step. If the field is absent, and 2-step and 4-
step does not have shared ROs, all 64 preambles are available for 2-step random access type.
msgA-TransMax
Max number of MsgA preamble transmissions performed before switching to 4-step random access
(see TS 38.321 [3], clauses 5.1.1). This field is only applicable when 2-step and 4-step RA type are
configured and switching to 4-step type RA is supported. If the field is absent, switching from 2-step
RA type to 4-step RA type is not allowed.
ra-PrioritizationForAl
Indicates whether the field ra-Prioritization-r16 applies for Access Identities. The first/leftmost bit
corresponds to Access Identity 1, the next bit corresponds to Access Identity 2. Value 1 indicates that
the field ra-Prioritization-r16 applies, otherwise the field does not apply.
ra-ContentionResolution Timer
The initial value for the contention resolution timer for fallback RAR in case no 4-step random access
type is configured (see TS 38.321 [3], clause 5.1.5). Value sf8 corresponds to 8 subframes, value sf16
corresponds to 16 subframes, and so on. If both 2-step and 4-step random access type resources are
configured on the BWP, then this field is absent.
ra-Prioritization
Parameters which apply for prioritized random access procedure on any UL BWP of SpCell for
specific Access Identities (see TS 38.321 [3], clause 5.1.1a).
rach-ConfigGeneric TwoStepRA
2-step random access type parameters for both regular random access and beam failure recovery.

GroupB-ConfiguredTwoStepRA field descriptions

messagePowerOffsetGroupB
Threshold for preamble selection. Value is in dB. Value minusinfinity
corresponds to −infinity. Value dB0 corresponds to 0 dB, dB5 corresponds
to 5 dB and so on. (see TS 38.321 [3], clause 5.1.1).
numberofRA-PreamblesGroupA
The number of CB preambles per SSB in group A for idle/inactive or
connected mode. The setting of the number of preambles for each group
should be consistent with ssb-perRACH-OccasionAndCB-
PreamblesPerSSB-TwoStepRA or msgA-CB-PreamblesPerSSB if
configured.
ra-MsgA-SizeGroupA
Transport block size threshold in bits below which the UE shall use a
contention-based RA preamble of group A. (see TS 38.321 [3], clause
5.1.1).

| Conditional | |
|---|---|
| Presence | Explanation |
| 2StepOnlyL139 | The field is mandatory present if prach- |
| | RootSequenceIndex L = 139 and no 4-step random |
| | access type is configured, otherwise the field is absent, |
| | Need S. |
| 2StepOnly | The field is mandatory present if there are no 4-step |
| | random access configurations configured in the BWP, |
| | i.e. only 2-step random access type configured in the |
| | BWP, otherwise the field is Need S. |
| SharedRO | The field is mandatory present if the 2-step random |
| | access type occasions are shared with 4-step random |
| | access type, otherwise the field is not present. |
| 2Step4Step | The field is mandatory present if both 2-step random |
| | access type and 4-step random access type are configured |
| | in the BWP, otherwise the field is not present. |
| InitialBWP- | This field is optionally present, Need R, if this BWP is |
| Only | the initial BWP of SpCell. Otherwise the field is absent. |

RACH-ConfigDedicated information element

-- ASN1START
-- TAG-RACH-CONFIGDEDICATED-START

| RACH-ConfigDedicated ::= | SEQUENCE { | |
|---|---|---|
| cfra | CFRA | OPTIONAL, -- Need S |

| | |
|---|---|
| ra-Prioritization | OPTIONAL, -- Need N |

```
  ...,
  [[
```

| | | |
|---|---|---|
| ra-PrioritizationTwoStep-r16 | RA-Prioritization | OPTIONAL, -- Need N |
| cfra-TwoStep-r16 | CFRA-TwoStep-r16 | OPTIONAL -- Need S |

]]
}

| | |
|---|---|
| CFRA ::= | SEQUENCE { |
| occasions | SEQUENCE { |
| rach-ConfigGeneric | RACH-ConfigGeneric, |
| ssb-perRACH-Occasion | ENUMERATED {oneEighth, oneFourth, oneHalf, one, two, four, eight, |

sixteen}

| | |
|---|---|
| | OPTIONAL -- Cond Mandatory |
| } | OPTIONAL, -- Need S |

| | |
|---|---|
| resources | CHOICE { |
| ssb | SEQUENCE { |
| ssb-ResourceList | SEQUENCE (SIZE(1..maxRA-SSB-Resources)) OF CFRA-SSB- |

Resource,

| | |
|---|---|
| ra-ssb-OccasionMaskIndex | INTEGER (0..15) |

},

| | |
|---|---|
| csirs | SEQUENCE { |
| csirs-ResourceList | SEQUENCE (SIZE(1..maxRA-CSIRS-Resources)) OF CFRA-CSIRS- |

Resource,

| | |
|---|---|
| rsrp-ThresholdCSI-RS | RSRP-Range |

```
    }
  },
  ...,
  [[
```

| | |
|---|---|
| totalNumberOfRA-Preambles INTEGER (1..63) | OPTIONAL -- Cond |

Occasions
]]
}

| | |
|---|---|
| CFRA-TwoStep-r16 ::= | SEQUENCE { |
| occasionsTwoStepRA-r16 | SEQUENCE { |
| rach-ConfigGenericTwoStepRA-r16 | RACH-ConfigGenericTwoStepRA-r16, |
| ssb-PerRACH-OccasionTwoStepRA-r16 | ENUMERATED {oneEighth, oneFourth, oneHalf, one, |
| | two, four, eight, sixteen} |

| | |
|---|---|
| } | OPTIONAL, -- Need S |

| | |
|---|---|
| msgA-CFRA-PUSCH-r16 | MsgA-PUSCH-Resource-r16, |
| msgA-TransMax-r16 | ENUMERATED {n1, n2, n4, n6, n8, n10, n20, n50, n 100, n200} |

OPTIONAL, -- Need S

| | |
|---|---|
| resourcesTwoStep-r16 | SEQUENCE { |
| ssb-ResourceList | SEQUENCE (SIZE(1..maxRA-SSB-Resources)) OF CFRA-SSB- |

Resource,

| | |
|---|---|
| ra-ssb-OccasionMaskIndex | INTEGER (0..15) |

```
  },
  ...
}
```

| | |
|---|---|
| CFRA-SSB-Resource ::= | SEQUENCE { |
| ssb | SSB-Index, |
| ra-PreambleIndex | INTEGER (0..63), |

```
  ...,
  [[
```

| | | |
|---|---|---|
| msgA-PUSCH-resource-Index-r16 | INTEGER (0..3071) | OPTIONAL -- Cond 2StepCFRA |

]]
}

| | |
|---|---|
| CFRA-CSIRS-Resource ::= | SEQUENCE { |
| csi-RS | CSI-RS-Index, |
| ra-OccasionList | SEQUENCE (SIZE(1..maxRA-OccasionsPerCSIRS)) OF INTEGER |

(0..maxRA-Occasions−1),

| | |
|---|---|
| ra-PreambleIndex | INTEGER (0..63), |

...
}
TAG-RACH-CONFIGDEDICATED-STOP
-- ASN1STOP

CFRA-CSIRS-Resource field descriptions

csi-RS
The ID of a CSI-RS resource defined in the measurement object associated with this serving cell.
ra-OccasionList
RA occasions that the UE shall use when performing CF-RA upon selecting the candidate beam
identified by this CSI-RS. The network ensures that the RA occasion indexes provided herein are also
configured by prach-ConfigurationIndex and msg1-FDM. Each RACH occasion is sequentially
numbered, first, in increasing order of frequency resource indexes for frequency multiplexed PRACH
occasions; second, in increasing order of time resource indexes for time multiplexed PRACH
occasions within a PRACH slot and Third, in increasing order of indexes for PRACH slots.
ra-Preamblelndex
The RA preamble index to use in the RA occasions associated with this CSI-RS.

CFRA field descriptions

occasions
RA occasions for contention free random access. If the field is absent, the UE uses the RA occasions
configured in RACH-ConfigCommon in the first active UL BWP.
ra-ssb-OccasionMaskIndex
Explicitly signaled PRACH Mask Index for RA Resource selection in TS 38.321 [3]. The mask is valid
for all SSB resources signaled in ssb-ResourceList.
rach-ConfigGeneric
Configuration of contention free random access occasions for CFRA. The UE shall ignore
preambleReceivedTargetPower, preamble TransMax, powerRampingStep, ra-ResponseWindow
signaled within this field and use the corresponding values provided in RACH-ConfigCommon.
ssb-perRACH-Occasion
Number of SSBs per RACH occasion.
totalNumberOfRA-Preambles
Total number of preambles used for contention free random access in the RACH resources defined in
CFRA, excluding preambles used for other purposes (e.g. for SI request). If the field is absent but the
field occasions is present, the UE may assume all the 64 preambles are for RA. The setting should be
consistent with the setting of ssb-perRACH-Occasion, if present, i.e. it should be a multiple of the
number of SSBs per RACH occasion.

CFRA-SSB-Resource field descriptions

msgA-PUSCH-resource-Index
Identifies the index of the PUSCH resource used for MSGA CFRA. The PUSCH resource index
indicates a valid PUSCH occasion (as specified in TS 38.213 [13], subclause 8.1A) and the
associated DMRS resources corresponding to a PRACH slot. The PUSCH resource indexes are
sequentially numbered and are mapped to valid PUSCH occasions corresponding to a PRACH slot
which are ordered, first, in increasing order of frequency resource indexes for frequency multiplexed
PUSCH occasions; second, in increasing order of DMRS resource indexes within a PUSCH occasion,
where a DMRS resource index D MRS id is determined first in an ascending order of a DMRS port
index and then in an ascending order of a DMRS sequence index, third in increasing order of time
resource indexes for time multiplexed PUSCH occasions within a PUSCH slot and fourth, in
increasing order of indexes for PUSCH slots. For the case of contention free 2-step random access
type, if this field is absent, the UE shall use the value 0.
ra-PreambleIndex
The preamble index that the UE shall use when performing CF-RA upon selecting the candidate
beams identified by this SSB.
ssb
The ID of an SSB transmitted by this serving cell.

CFRA-TwoStep field descriptions

msgA-CFRA-PUSCH
PUSCH resource configuration(s) for msgA CFRA.
msgA-TransMax
Max number of MsgA preamble transmissions performed before switching
to 4-step type random access (see TS 38.321 [3], clauses 5.1.1). This field
is only applicable when 2-step and 4-step RA type are configured and
switching to 4-step type RA is supported. If the field is absent in
RACH-ConfigDedidated, switching from 2-step RA type to 4-step RA
type is not allowed.
occasionsTwoStepRA
RA occasions for contention free random access. If the field is absent, the
UE uses the RA occasions configured in RACH-
ConfigCommonTwoStepRA in the first active UL BWP.
ra-SSB-OccasionMaskIndex
Explicitly signaled PRACH Mask Index for RA Resource selection in TS
38.321 [3]. The mask is valid for all SSB resources signaled in ssb-
ResourceList.
rach-ConfigGenericTwoStepRA
Configuration of contention free random access occasions for CFRA
2-step random access type.
ssb-PerRACH-OccasionTwoStep
Number of SSBs per RACH occasion for 2-step random access type.

RACH-ConfigDedicated field descriptions

cfra
Parameters for contention free random access to a given target cell. If this
field and cfra-TwoStep are absent, the UE performs contention based
random access.
cfra-TwoStep
Parameters for contention free 2-step random access type to a given target
cell. Network ensures that cfra and cfra-TwoStep are not configured at the
same time. If this field and cfra are absent, the UE performs contention
based random access. This field may only be present if msgA-
ConfigCommon is configured on the BWP.
ra-prioritization
Parameters which apply for prioritized random access procedure to a given
target cell (see TS 38.321 [3], clause 5.1.1).
ra-PrioritizationTwoStep
Parameters which apply for prioritized 2-step random access type
procedure to a given target cell (see TS 38.321 [3], clause 5.1.1).

| Conditional | |
|---|---|
| Presence | Explanation |
| Mandatory | The field is mandatory present. |
| Occasions | The field is optionally present, Need S, if the field |
| | occasions is present, otherwise it is absent. |
| 2StepCFRA | The field is optionally present for the case of 2-step |
| | RA type contention free random access, Need S, |
| | otherwise it is absent. |

MsgA-ConfigCommon information element

-- ASN1START
-- TAG-MSGACONFIGCOMMON-START

| MsgA-ConfigCommon-r16 ::= | SEQUENCE { | |
|---|---|---|
| rach-ConfigCommonTwoStepRA-r16 | RACH-ConfigCommonTwoStepRA-r16, | |
| msgA-PUSCH-Config-r16 | MsgA-PUSCH-Config-r16 | OPTIONAL -- Cond |

InitialBWPConfig
-- TAG-MSGACONFIGCOMMON-STOP
-- ASN1STOP

MsgA-ConfigCommon field descriptions

msgA-PUSCH-Config
Configuration of cell-specific MsgA PUSCH parameters which the UE
uses for contention-based MsgA PUSCH transmission of this BWP. If the
field is not configured for the selected UL BWP, the UE shall use the
MsgA PUSCH configuration of initial UL BWP.
rach-ConfigCommonTwoStepRA
Configuration of cell specific random access parameters which the
UE uses for contention based and contention free 2-step random access
type procedure as well as for 2-step RA type contention based beam
failure recovery in this BWP.

| Conditional | |
|---|---|
| Presence | Explanation |
| InitialBWPConfig | The field is mandatory present when MsgA- |
| | ConfigCommon is configured for the initial uplink |
| | BWP, or when MsgA-ConfigCommon is configured |
| | for a non-initial uplink BWP and MsgA- |
| | ConfigCommon is not configured for the initial |
| | uplink BWP, otherwise the field is Need S. |

MsgA-PUSCH-Config information element

-- ASN1START
-- TAG-MSGA-PUSCH-CONFIG-START

| | |
|---|---|
| MsgA-PUSCH-Config-r16 ::= | SEQUENCE { |
| msgA-PUSCH-ResourceGroupA-r16 | MsgA-PUSCH-Resource-r16 |

OPTIONAL, -- Cond InitialBWPConfig

| | |
|---|---|
| msgA-PUSCH-ResourceGroupB-r16 | MsgA-PUSCH-Resource-r16 |

OPTIONAL, -- Cond GroupBConfigured

| | |
|---|---|
| msgA-TransformPrecoder-r16 | ENUMERATED {enabled, disabled} |

OPTIONAL, -- Need R

| | | |
|---|---|---|
| msgA-DataScramblingIndex-r16 | INTEGER (0..1023) | OPTIONAL, |

-- Need S

| | | |
|---|---|---|
| msgA-DeltaPreamble-r16 | INTEGER (−1..6) | OPTIONAL -- |

Need R
}

| | |
|---|---|
| MsgA-PUSCH-Resource-r16 ::= | SEQUENCE { |
| msgA-MCS-r16 | INTEGER (0..15), |
| nrofSlotsMsgA-PUSCH-r16 | INTEGER (1..4), |
| nrofMsgA-PO-PerSlot-r16 | ENUMERATED {one, two, three, six}, |
| msgA-PUSCH-TimeDomainOffset-r16 | INTEGER (1..32), |
| msgA-PUSCH-TimeDomainAllocation-r16 | INTEGER (1..maxNrofUL-Allocations) |

OPTIONAL, -- Need S

| | |
|---|---|
| startSymbolAndLengthMsgA-PO-r16 | INTEGER (0..127) |

OPTIONAL, -- Need S

| | |
|---|---|
| mappingTypeMsgA-PUSCH-r16 | ENUMERATED {typeA, typeB} |

OPTIONAL, -- Need S

| | | |
|---|---|---|
| guardPeriodMsgA-PUSCH-r16 | INTEGER (0..3) | OPTIONAL, -- |

Need R

| | |
|---|---|
| guardBandMsgA-PUSCH-r16 | INTEGER (0..1), |
| frequencyStartMsgA-PUSCH-r16 | INTEGER (0..maxNrofPhysicalResourceBlocks−1), |
| nrofPRBs-PerMsgA-PO-r16 | INTEGER (1..32), |
| nrofMsgA-PO-FDM-r16 | ENUMERATED {one, two, four, eight}, |
| msgA-IntraSlotFrequencyHopping-r16 | ENUMERATED {enabled} |

OPTIONAL, -- Need R

| | | |
|---|---|---|
| msgA-HoppingBits-r16 | BIT STRING (SIZE(2)) | OPTIONAL, -- |

Need R

| msgA-DMRS-Config-r16 | MsgA-DMRS-Config-r16, | |
|---|---|---|
| nrofDMRS-Sequences-r16 | INTEGER (1..2), | |
| msgA-Alpha-r16 | ENUMERATED {alpha0, alpha04, alpha05, alpha06, | |
| | alpha07, alpha08, alpha09, alpha1} | OPTIONAL, -- Need S |

| | |
|---|---|
| interlaceIndexFirstPO-MsgA-PUSCH-r16 | INTEGER (1..10) |

OPTIONAL, -- Need R

| | | |
|---|---|---|
| nrofInterlacesPerMsgA-PO-r16 | INTEGER (1..10) | OPTIONAL, -- |

Need R
...
}

| | |
|---|---|
| MsgA-DMRS-Config-r16 ::= | SEQUENCE { |
| msgA-DMRS-AdditionalPosition-r16 | ENUMERATED {pos0, pos1, pos3} |

OPTIONAL, -- Need S

| | | |
|---|---|---|
| msgA-MaxLength-r16 | ENUMERATED {len2} | OPTIONAL, -- |

Need S

| | |
|---|---|
| msgA-PUSCH-DMRS-CDM-Group-r16 | INTEGER (0..1) |

OPTIONAL, -- Need S

| | | |
|---|---|---|
| msgA-PUSCH-NrofPorts-r16 | INTEGER (0..1) | OPTIONAL, -- |

Need S

| | | |
|---|---|---|
| msgA-ScramblingID0-r16 | INTEGER (0..65536) | OPTIONAL, -- |

Need S

| | | |
|---|---|---|
| msgA-ScramblingID1-r16 | INTEGER (0..65536) | OPTIONAL -- |

Need S
}
-- TAG-MSGA-PUSCH-CONFIG-STOP
-- ASN1STOP

MsgA-PUSCH-Config field descriptions

msgA-DataScramblingIndex
Identifier used to initiate data scrambling (c_init) for msgA PUSCH. If
the field is absent the UE applies the value Physical cell ID
(physCellID).
msgA-DeltaPreamble
Power offset of msgA PUSCH relative to the preamble received target
power (see TS 38.213 [13], clause 7.1).
msgA-PUSCH-ResourceGroupA
MsgA PUSCH resources that the UE shall use when performing MsgA
transmission using preambles group A. If field is not configured for the
selected UL BWP, the UE shall use the MsgA PUSCH configuration for
group A of initial UL BWP.
msgA-PUSCH-ResourceGroupB
MsgA PUSCH resources that the UE shall use when performing MsgA
transmission using preambles group B.
msgA-TransformPrecoder
Enables or disables the transform precoder for MsgA transmission
(see clause 6.1.3 of TS 38.214 [19]).

MsgA-PUSCH-Resource field descriptions

guardBandMsgA-PUSCH
PRB-level guard band between FDMed PUSCH occasions (see TS 38.213 [13], clause 8.1A).
guardPeriodMsgA-PUSCH
Guard period between PUSCH occasions in the unit of symbols (see TS 38.213 [13], clause 8.1A).
frequencyStartMsgA-PUSCH
Offset of lowest PUSCH occasion in frequency domain with respect to PRB 0 (see TS 38.213 [13],
clause 8.1A).
interlaceIndexFirstPO-MsgA-PUSCH
Interlace index of the first PUSCH occasion in frequency domain if interlaced PUSCH is configured.
For 30 KHz SCS only the integers 1, 2, 3, 4, 5 are applicable (see TS 38.213 [13], clause 8.1A).
mappingTypeMsgA-PUSCH
PUSCH mapping type A or B. If the field is absent, the UE shall use the parameter msgA-PUSCH-
TimeDomainAllocation (see TS 38.213 [13], clause 8.1A).
msgA-Alpha
Dedicated alpha value for MsgA PUSCH. If value is absent, the UE shall use the value of msg3-Alpha
if configured, else UE applies value 1 (see TS 38.213 [13], clause 7.1.1).
msgA-DMRS-Config
DMRS configuration for msgA PUSCH (see TS 38.213 [13], clause 8.1A and TS 38.214 [19] clause
6.2.2).
msgA-HoppingBits
Value of hopping bits to indicate which frequency offset to be used for second hop. See Table 8.3-1 in
38.213 [13].
msgA-IntraSlotFrequencyHopping
Intra-slot frequency hopping per PUSCH occasion (see TS 38.213 [13], clause 8.1A).
msgA-MCS
Indicates the MCS index for msgA PUSCH from the Table 6.1.4.1-1 for DFT-s-OFDM and Table
5.1.3.1-1 for CP-OFDM in 38.214 [19].
msgA-PUSCH-TimeDomainAllocation
Indicates a combination of start symbol and length and PUSCH mapping type from the TDRA table
(PUSCH-TimeDomainResourceAllocationList if provided in PUSCH-ConfigCommon, or else the
default Table 6.1.2.1.1-2 in 38.214 [19] is used if pusch-TimeDomainAllocationList is not provided in
PUSCH-ConfigCommon). The parameter K2 in the table is not used for msgA PUSCH. The network
configures one of msgA-PUSCH-TimeDomainAllocation and startSymbolAndLengthMsgA-PO, but not
both. If the field is absent, the UE shall use the value of startSymbolAndLenghtMsgA-PO.
msgA-PUSCH-TimeDomainOffset
A single time offset with respect to the start of each PRACH slot (with at least one valid RO), counted
as the number of slots (based on the numerology of active UL BWP). See 38.213 [13], clause 8.1A.
nrofDMRS-Sequences
Number of DMRS sequences for MsgA PUSCH for CP-OFDM. In case of single PUSCH configuration
or if the DMRS symbols of multiple configurations are not overlapped, if the DMRS resources
configured in one PUSCH occasion is no larger than 8 (for len2) or 4 (for len1), then only DMRS port
is configured.
nrofInterlacesPerMsgA-PO
Number of consecutive interlaces per PUSCH occasion if interlaced PUSCH is configured. For 30 kHz
SCS only the integers 1, 2, 3, 4, 5 are applicable (see TS 38.213 [13], clause 8.1A).
nrofMsgA-PO-FDM
The number of msgA PUSCH occasions FDMed in one time instance (see TS 38.213 [13], clause
8.1A).
nrofMsgA-PO-PerSlot
Number of time domain PUSCH occasions in each slot. PUSCH occasions including guard period are
contiguous in time domain within a slot (see TS 38.213 [13], clause 8.1A).
nrofPRBs-PerMsgA-PO
Number of PRBs per PUSCH occasion (see TS 38.213 [13], clause 8.1A).
nrofSlotsMsgA-PUSCH
Number of slots (in active UL BWP numerology) containing one or multiple PUSCH occasions, each
slot has the same time domain resource allocation (see TS 38.213 [13], clause 8.1A).
startSymbolAndLengthMsgA-PO
An index giving valid combinations of start symbol, length and mapping type as start and length
indicator (SLIV) for the first msgA PUSCH occasion, for RRC_CONNECTED UEs in non-initial BWP
as described in TS 38.214 [19] clause 6.1.2. The network configures the field so that the allocation
does not cross the slot boundary. The number of occupied symbols excludes the guard period. If the
field is absent, the UE shall use the value in msgA-PUSCH-TimeDomainAllocation (see TS 38.213
[13], clause 8.1A). The network configures one of msgA-PUSCH-TimeDomainAllocation and
startSymbolAndLengthMsgA-PO, but not both. If the field is absent, the UE shall use the value of
msgA-PUSCH-TimeDomainAllocation.

MsgA-DMRS-Config field descriptions

msgA-DMRS-AdditionalPosition
Indicates the position for additional DM-RS. If the field is absent, the
UE applies value pos2.
msgA-MaxLength
indicates single-symbol or double-symbol DMRS. If the field is absent, the
UE applies value len1.
msgA-PUSCH-DMRS-CDM-group
1-bit indication of indices of CDM group(s). If the field is absent, then
both CDM groups are used.
msgA-PUSCH-NrofPort
0 indicates 1 port per CDM group, 1 indicates 2 ports per CDM
group. If the field is absent then 4 ports per CDM group are used.
msgA-ScramblingID0
UL DMRS scrambling initialization for CP-OFDM. If the field is
absent the UE applies the value Physical cell ID (physCellID).
msgA-ScramblingID1
UL DMRS scrambling initialization for CP-OFDM. If the field is
absent the UE applies the value Physical cell ID (physCellID).

| Conditional | |
|---|---|
| Presence | Explanation |
| GroupBConfigured | The field is mandatory present if groupB- |
| | ConfiguredTwoStepRA is configured in RACH- |
| | ConfigCommon TwoStepRA, otherwise the field |
| | is absent. |
| InitialBWPConfig | The field is mandatory present when MsgA- |
| | ConfigCommon is configured for the initial |
| | uplink BWP, or when MsgA-ConfigCommon is |
| | configured for a non-initial uplink BWP and |
| | MsgA-ConfigCommon is not configured for the |
| | initial uplink BWP, otherwise the field is Need S. |

III. 4-Step RA in NR

A. 4-Step RA Procedure in NR

A 4-step approach is used for the NR Rel-15 random access procedure, see FIG. 1. In this approach, the UE detects a SS and decodes the broadcasted system information before it initiates the actual random access procedure. To initiate the random access procedure, the UE transmits a random access preamble on the Physical Random Access Channel (PRACH) (referred to as message 1 (Msg1)) in the uplink using the transmission resources of a PRACH occasion (also referred to as RACH occasion (RO)) as configured by the system information. The gNB replies with a Random Access Response (RAR) message (referred to as message 2 (Msg2)). The UE then transmits a UE identification (referred to as message 3 (Msg3)) on the PUSCH, wherein the UE identification may be a 5G-S-Temporary Mobile Subscriber Identity (TMSI) in an RRCSetupRequest message (if the UE is in RRC_IDLE state) or an Inactive Radio Network Temporary Identifier (I-RNTI) in an RRCResumeRequest message (if the UE is in RRC_INACTIVE state) or a Cell Radio Network Temporary Identifier (C-RNTI) in a C-RNTI MAC Control Element (CE) in a MAC Protocol Data Unit (PDU) typically containing user plane data (if the UE is in RRC_CONNECTED state). This is referred to as message 3 (Msg3) and is transmitted on uplink resources allocated by the RAR message. As a last step, the gNB transmits a contention resolution message (referred to as message 4 (Msg4)), wherein a UE Contention Resolution Identification MAC CE is included, containing the 48 first bits of Msg3, in order to resolve a possible situation where two or more UEs have transmitted the same preamble in the same PRACH occasion.

The UE transmits PUSCH (message 3) after receiving a timing advance command in the RAR, allowing PUSCH to be received with a timing accuracy within the cyclic prefix. Without this timing advance, a very large Cyclic Prefix (CP) would be needed in order to be able to detect and demodulate the PUSCH transmission, unless the system is applied in a cell with very small distance between UE and enhanced or evolved Node B (eNB). Since NR will also support larger cells with a need for providing a timing advance to the UE, the 4-step random access procedure is designed to allow the UE to transmit on the PUSCH with a proper timing advance rather than a very large CP.

Note that the above description of the 4-step RA procedure applies in its entirety only in the case of Contention-Based Random Access (CBRA). In the case of Contention-Free Random Access (CFRA), the random access procedure is in principle regarded as completed by the reception of the RAR message (provided that it includes a response to the CFRA preamble the UE transmitted).

B. NR Rel-15 PRACH Configuration for 4-Step RA

In NR, the time and frequency resource on which a PRACH preamble is transmitted is defined as a PRACH occasion. In this disclosure, the PRACH occasion is also called RACH occasion, or RA occasion, or in short RO. And sometimes the RO used for the transmission of the preambles in 2-step RA is called 2-step RO, while the RO used for the transmission of the preambles in 4-step RA is called 4-step RO.

The time resources and preamble format for PRACH transmission are configured by a PRACH configuration index, which indicates a row in a PRACH configuration table specified in 3GPP TS 38.211 rev. 15.6.0 Tables 6.3.3.2-2, 6.3.3.2-3, 6.3.3.2-4 for Frequency Range (FR)1 paired spectrum, FR1 unpaired spectrum and FR2 with unpaired spectrum, respectively.

Part of the Table 6.3.3.2-3 for FR1 unpaired spectrum for PRACH preamble format 0 is copied in Table 1 below, where the value of x indicates the PRACH configuration period in number of system frames. The value of y indicates the system frame within each PRACH configuration period on which the PRACH occasions are configured. For instance, if y is set to 0, then, it means PRACH occasions only configured in the first frame of each PRACH configuration period. The values in the column “subframe number” indicate which subframes are configured with PRACH occasion. The values in the column “starting symbol” are the symbol index.

In case of TDD, semi-statically configured DL parts and/or actually transmitted SSBs can override and invalidate some time-domain PRACH occasions defined in the PRACH configuration table. More specifically, PRACH occasions in the UL part are always valid, and a PRACH occasion within the X part is valid as long as it does not precede or collide with an SSB in the PRACH slot and it is at least N symbols after the DL part and the last symbol of an SSB. N is 0 or 2 depending on PRACH format and subcarrier spacing.

TABLE 1
PRACH configuration for preamble format 0 for FR1 unpaired spectrum.

| | | | | | | | Nₜ^{RA, slot}, | |
|---|---|---|---|---|---|---|---|---|
| | | | | | | | number | |
| | | | | | | | of time- | |
| | | | | | | Number | domain | |
| | | | | | | of | PRACH | |
| | | | | | | PRACH | occasions | |
| PRACH | | | | | | slots | within a | N_{dur}^{RA}, |
| Configuration | Preamble | n_{SFN} mod x = y | | Subframe | Starting | within a | PRACH | PRACH |
| Index | format | x | y | number | symbol | subframe | slot | duration |
| 0 | 0 | 16 | 1 | 9 | 0 | — | — | 0 |
| 1 | 0 | 8 | 1 | 9 | 0 | — | — | 0 |
| 2 | 0 | 4 | 1 | 9 | 0 | — | — | 0 |
| 3 | 0 | 2 | 0 | 9 | 0 | — | — | 0 |
| 4 | 0 | 2 | 1 | 9 | 0 | — | — | 0 |
| 5 | 0 | 2 | 0 | 4 | 0 | — | — | 0 |
| 6 | 0 | 2 | 1 | 4 | 0 | — | — | 0 |
| 7 | 0 | 1 | 0 | 9 | 0 | — | — | 0 |
| 8 | 0 | 1 | 0 | 8 | 0 | — | — | 0 |
| 9 | 0 | 1 | 0 | 7 | 0 | — | — | 0 |
| 10 | 0 | 1 | 0 | 6 | 0 | — | — | 0 |
| 11 | 0 | 1 | 0 | 5 | 0 | — | — | 0 |
| 12 | 0 | 1 | 0 | 4 | 0 | — | — | 0 |
| 13 | 0 | 1 | 0 | 3 | 0 | — | — | 0 |
| 14 | 0 | 1 | 0 | 2 | 0 | — | — | 0 |
| 15 | 0 | 1 | 0 | 1, 6 | 0 | — | — | 0 |
| 16 | 0 | 1 | 0 | 1, 6 | 7 | — | — | 0 |
| 17 | 0 | 1 | 0 | 4, 9 | 0 | — | — | 0 |
| 18 | 0 | 1 | 0 | 3, 8 | 0 | — | — | 0 |
| 19 | 0 | 1 | 0 | 2, 7 | 0 | — | — | 0 |
| 20 | 0 | 1 | 0 | 8, 9 | 0 | — | — | 0 |
| 21 | 0 | 1 | 0 | 4, 8, 9 | 0 | — | — | 0 |
| 22 | 0 | 1 | 0 | 3, 4, 9 | 0 | — | — | 0 |
| 23 | 0 | 1 | 0 | 7, 8, 9 | 0 | — | — | 0 |
| 24 | 0 | 1 | 0 | 3, 4, 8, 9 | 0 | — | — | 0 |
| 25 | 0 | 1 | 0 | 6, 7, 8, 9 | 0 | — | — | 0 |
| 26 | 0 | 1 | 0 | 1, 4, 6, 9 | 0 | — | — | 0 |
| 27 | 0 | 1 | 0 | 1, 3, 5, 7, 9 | 0 | — | — | 0 |

In the frequency domain, NR supports multiple frequency-multiplexed (also referred to as FDMed) PRACH occasions on the same time-domain PRACH occasion. This is mainly motivated by the support of analog receive beam sweeping in NR gNBs, such that the PRACH occasions associated with one SSB are configured at the same time instance but different frequency locations. The number of PRACH occasions FDMed in one time domain PRACH occasion, can be 1, 2, 4, or 8. FIG. 2 gives an example of the PRACH occasion configuration in NR.

In NR Rel-15, there are up to 64 sequences that can be used as random-access preambles per PRACH occasion in each cell. The RRC parameter totalNumberOfRA-Preambles determines how many of these 64 sequences are used as random-access preambles per PRACH occasion in each cell. The 64 sequences are configured by including firstly all the available cyclic shifts of a root Zadoff-Chu sequence, and secondly in the order of increasing root index, until 64 preambles have been generated for the PRACH occasion.

C. Random Access Response Reception

In 4-step RA, after transmitting the random access preamble, the UE starts a timer for a RAR message response window, i.e. a time window during which the UE expects to receive a RAR message from the network. More precisely, the UE starts the timer for the RAR window at the first PDCCH occasion which is at least one symbol after the PRACH occasion used for the preamble transmission. This is described as follows in chapter 8.2 in 3GPP TS 38.213 version 16.1.0:
In response to a PRACH transmission, a UE attempts to detect a DCI format 1_0 with CRC scrambled by a corresponding RA-RNTI during a window controlled by higher layers [11, TS 38.321]. The window starts at the first symbol of the earliest CORESET the UE is configured to receive PDCCH for Type1-PDCCH CSS set, as defined in Clause 10.1, that is at least one symbol, after the last symbol of the PRACH occasion corresponding to the PRACH transmission, where the symbol duration corresponds to the SCS for Type1-PDCCH CSS set as defined in Clause 10.1. The length of the window in number of slots, based on the SCS for Type1-PDCCH CSS set, is provided by ra-ResponseWindow.

While the timer for the RAR window is running, the UE monitors the PDCCH for downlink assignments addressed to the RA-RNTI which is derived from the time and frequency resources the UE used for the transmission of the random access preamble. The UE stops this monitoring if a RAR is received or the time expires (i.e., the end of the RAR window is reached without RAR reception). If the timer expires, the UE may reattempt another preamble transmission, unless a configured maximum number has been reached, in which case the UE concludes that the random access has failed. The RAR window size is configurable between 1 slot and 40 slots, where the time duration of a slot depends on the numerology (characterized by the subcarrier spacing, SCS): 10 ms for 15 kHz SCS, 5 ms for 30 kHz SCS, 2.5 ms for 60 kHz SCS and 1.25 ms for 120 kHz SCS.

The following is the relevant text for RAR response in the MAC specification 3GPP TS 38.321 version 16.1.0 (the content of chapter 5.1.4 “Random Access Response reception”):

“Once the Random Access Preamble is transmitted and regardless of the possible occurrence of a
measurement gap, the MAC entity shall:

| 1> | if the contention-free Random Access Preamble for beam failure recovery request was transmitted by | |
|---|---|---|
| | the MAC entity: | |
| | 2> | start the ra-ResponseWindow configured in BeamFailureRecoveryConfig at the first |
| | | PDCCH occasion as specified in TS 38.213 [6] from the end of the Random Access |
| | | Preamble transmission; |
| | 2> | monitor for a PDCCH transmission on the search space indicated by |
| | | recoverySearchSpaceId of the SpCell identified by the C-RNTI while ra-ResponseWindow |
| | | is running. |
| 1> | else: | |
| | 2> | start the ra-ResponseWindow configured in RACH-ConfigCommon at the first PDCCH |
| | | occasion as specified in TS 38.213 [6] from the end of the Random Access Preamble |
| | | transmission; |
| | 2> | monitor the PDCCH of the SpCell for Random Access Response(s) identified by the RA- |
| | | RNTI while the ra-ResponseWindow is running. |
| 1> | if notification of a reception of a PDCCH transmission on the search space indicated by | |
| | recoverySearchSpaceId is received from lower layers on the Serving Cell where the preamble was | |
| | transmitted; and | |
| 1> | if PDCCH transmission is addressed to the C-RNTI; and | |
| 1> | if the contention-free Random Access Preamble for beam failure recovery request was transmitted by | |
| | the MAC entity: | |
| | 2> | consider the Random Access procedure successfully completed. |
| 1> | else if a valid (as specified in TS 38.213 [6]) downlink assignment has been received on the PDCCH | |
| | for the RA-RNTI and the received TB is successfully decoded: | |
| | 2> | if the Random Access Response contains a MAC subPDU with Backoff Indicator: |

| | |
|---|---|
| 3> | set the PREAMBLE_BACKOFF to value of the BI field of the MAC subPDU using Table 7.2-1, |

multiplied with SCALING_FACTOR_BI.

| | |
|---|---|
| 2> | else: |

| | |
|---|---|
| 3> | set the PREAMBLE_BACKOFF to 0 ms. |

| | |
|---|---|
| 2> | if the Random Access Response contains a MAC subPDU with Random Access Preamble |

| identifier corresponding to the transmitted PREAMBLE_INDEX (see clause 5.1.3): | |
|---|---|
| 3> | consider this Random Access Response reception successful. |

| | |
|---|---|
| 2> | if the Random Access Response reception is considered successful: |

| | |
|---|---|
| 3> | if the Random Access Response includes a MAC subPDU with RAPID only: |

| | |
|---|---|
| 4> | consider this Random Access procedure successfully completed; |
| 4> | indicate the reception of an acknowledgement for SI request to upper layers. |

| | |
|---|---|
| 3> | else: |

| | |
|---|---|
| 4> | apply the following actions for the Serving Cell where the Random Access Preamble was |

| transmitted: | |
|---|---|
| 5> | process the received Timing Advance Command (see clause 5.2); |
| 5> | indicate the preambleReceivedTargetPower and the amount of power ramping applied |
| | to the latest Random Access Preamble transmission to lower layers (i.e. |
| | (PREAMBLE_POWER_RAMPING_COUNTER−1) × |
| | PREAMBLE_POWER_RAMPING_STEP); |
| 5> | if the Random Access procedure for an SCell is performed on uplink carrier where |

| pusch-Config is not configured: | | |
|---|---|---|
| 1> | 6> | ignore the received UL grant. |

| | |
|---|---|
| 5> | else: |

| | | |
|---|---|---|
| 2> | 6> | process the received UL grant value and indicate it to the lower layers. |

| | |
|---|---|
| 4> | if the Random Access Preamble was not selected by the MAC entity among the contention- |

| based Random Access Preamble(s): | |
|---|---|
| 5> | consider the Random Access procedure successfully completed. |

| | |
|---|---|
| 4> | else: |

| | |
|---|---|
| 5> | set the TEMPORARY_C-RNTI to the value received in the Random Access Response; |
| 5> | if this is the first successfully received Random Access Response within this Random |

| Access procedure: | | |
|---|---|---|
| 3> | 6> | if the transmission is not being made for the CCCH logical channel: |

| | |
|---|---|
| 7> | indicate to the Multiplexing and assembly entity to include a C-RNTI MAC CE in |

the subsequent uplink transmission.

| | | |
|---|---|---|
| 4> | 6> | if the Random Access procedure was initiated for SpCell beam failure |

| recovery: | |
|---|---|
| 7> | indicate to the Multiplexing and assembly entity to include a BFR MAC CE or a |

Truncated BFR MAC CE in the subsequent uplink transmission.

| | | |
|---|---|---|
| 5> | 6> | obtain the MAC PDU to transmit from the Multiplexing and assembly entity |

and store it in the Msg3 buffer.

| NOTE: | If within a Random Access procedure, an uplink grant provided in the Random Access | |
|---|---|---|
| | Response for the same group of contention-based Random Access Preambles has a different | |
| | size than the first uplink grant allocated during that Random Access procedure, the UE | |
| | behavior is not defined. | |
| 1> | if ra-ResponseWindow configured in BeamFailureRecoveryConfig expires and if a PDCCH | |
| | transmission on the search space indicated by recoverySearchSpaceId addressed to the C- | |
| | RNTI has not been received on the Serving Cell where the preamble was transmitted; or | |
| 1> | if ra-ResponseWindow configured in RACH-ConfigCommon expires, and if the Random | |
| | Access Response containing Random Access Preamble identifiers that matches the | |
| | transmitted PREAMBLE_INDEX has not been received: | |
| | 2> | consider the Random Access Response reception not successful; |
| | 2> | increment PREAMBLE_TRANSMISSION_COUNTER by 1; |
| | 2> | if PREAMBLE_TRANSMISSION_COUNTER = preambleTransMax + 1: |

| | |
|---|---|
| 3> | if the Random Access Preamble is transmitted on the SpCell: |

| | |
|---|---|
| 4> | indicate a Random Access problem to upper layers; |
| 4> | if this Random Access procedure was triggered for SI request: |

| | |
|---|---|
| 5> | consider the Random Access procedure unsuccessfully completed. |

| | |
|---|---|
| 3> | else if the Random Access Preamble is transmitted on an SCell: |

| | |
|---|---|
| 4> | consider the Random Access procedure unsuccessfully completed. |

| | |
|---|---|
| 2> | if the Random Access procedure is not completed: |

| 3> | select a random backoff time according to a uniform distribution between 0 and the |
|---|---|
| | PREAMBLE_BACKOFF; |
| 3> | if the criteria (as defined in clause 5.1.2) to select contention-free Random Access Resources |

| is met during the backoff time: | |
|---|---|
| 4> | perform the Random Access Resource selection procedure (see clause 5.1.2); |

| | |
|---|---|
| 3> | else if the Random Access procedure for an SCell is performed on uplink carrier where pusch- |

| Config is not configured: | |
|---|---|
| 4> | delay the subsequent Random Access transmission until the Random Access Procedure is |

triggered by a PDCCH order with the same ra-PreambleIndex, ra-ssb-OccasionMaskIndex,
and UL/SUL indicator TS 38.212 [9].

| | |
|---|---|
| 3> | else: |

| | |
|---|---|
| 4> | perform the Random Access Resource selection procedure (see clause 5.1.2) after the |

backoff time.

The MAC entity may stop ra-ResponseWindow (and hence monitoring for Random Access
Response(s)) after successful reception of a Random Access Response containing Random Access
Preamble identifiers that matches the transmitted PREAMBLE_INDEX.
HARQ operation is not applicable to the Random Access Response reception.”

IV. 2-Step RA in NR

An alternative to the regular 4-step RA procedure is introduced in NR in 3GPP release 16. This alternative RA type is called 2-step RA (or Type 2 RA).

A. 2-Step RA Procedure in NR

With the 2-step random access approach, a UE is able to complete a random access procedure in only two steps, as illustrated in FIG. 3:
Step 1: The UE sends a message A (msgA) including random access preamble (transmitted on the PRACH) together with a PUSCH transmission, typically containing higher layer data such as an RRC message (in the case of a UE in RRC_IDLE or RRC_INACTIVE state) or user plane data (in the case of a UE in RRC_CONNECTED state). The part of msgA transmitted on the PRACH, i.e. the random access preamble, is sometimes referred to as msgA preamble or 2-step preamble. The part of msgA transmitted on the PUSCH is herein often referred to as msgA PUSCH.
Step 2: The gNB sends a response, called message B (msgB). A msgB may contain a response to multiple UEs and it may also contain a backoff indicator, which is an indication to UEs which transmitted 2-step random access preamble in the concerned PRACH occasion, but which did not find any matching response in the received msgB. The response to a UE contained in a msgB may have the form of a successRAR (more strictly denoted successRAR MAC subPDU) or a fallbackRAR (more strictly denoted fallbackRAR MAC subPDU). The response is a successRAR in case the gNB successfully received msgA, including both the preamble and the msgA PUSCH transmission. The fallbackRAR is used in the case where the gNB only received the preamble but failed to receive the msgA PUSCH transmission and chooses to instruct the UE to fallback to 4-step RA for the remainder of the RA procedure, i.e. to conclude the random access procedure with a msg3 (retransmitting the content of msgA PUSCH) and a msg4. A successRAR MAC subPDU includes a UE contention resolution identity, a timing advance command, a C-RNTI assigned to the UE and HARQ feedback configuration consisting of a transmit power control command for a Physical Uplink Control Channel (PUCCH), Hybrid Automatic Repeat Request (HARQ) feedback timing information and a PUCCH resource indicator. The content of a fallbackRAR MAC subPDU is the same as in a MAC RAR, i.e. the response to a UE in the RAR message, that is, a timing advance command, a UL grant, and a temporary C-RNTI. MsgB and its content are specified in the MAC specification 3GPP TS 38.321.

Note that the above description of the 2-step RA procedure applies in its entirety only in the case of CBRA. In the case of CFRA, msgB is used only in the case of fallback to 4-step RA (i.e., with a fallbackRAR addressed to the UE) whereas in the successful case, the 2-step random access procedure is concluded by a PDCCH downlink assignment addressed to the UE's C-RNTI, with an Absolute Timing Advance Command MAC CE contained in the associated PUSCH transmission.

One of the benefits of 2-step RA is the latency gains. Depending on the numerology that is used in NR, the 2-step RA procedure could lead to a reduction of approximately factor 3 compared to the 4-step RA procedure (see FIG. 4).

When both 4-step RA and 2-step RA are configured in a cell, a UE selects which RA type to use based on the RSRP the UE experiences in the cell. If the measured RSRP exceeds an RA type selection threshold, the UE selects 2-step RA, otherwise the UE selects 4-step RA.

B. 2-Step RA Configuration

In 2-step RA, a preamble is associated with a so called PUSCH Resource Unit (RU), which is used for the msgA PUSCH transmission. A PUSCH RU consists of a PUSCH Occasion (PO), which consists of the time/frequency resource allocation for the transmission, combined with the DMRS configuration (DMRS port and DMRS sequence initialization) to be used for the msgA PUSCH transmission.

Regarding the PRACH occasions (or RACH occasions, ROs), the ROs for 2-step RA may be shared with the ROs for 4-step RA or separate (used only for 2-step RA). Either shared ROs or separate ROs are configured in a cell—they cannot both be used in parallel. When shared ROs are configured, separate RA preamble ranges are configured for 4-step RA and 2-step RA.

Hence, there will be a set of preambles that are dedicated for use for 2-step RA in a cell where shared ROs are configured for 2-step RA and 4-step RA. When this configuration option is used, 2-step RA may be configured for all or a subset of the ROs configured for 4-step RA and the ROs which are shared are indicated by a configured mask. This mask can hence be used to achieve a configuration where some ROs are shared while some ROs are used only for 4-step RA. However, the opposite is not possible, i.e. there may be no ROs only for 2-step RA when shared ROs are configured.

To configure ROs dedicated for 2-step RA, the alternative configuration option, i.e. separate ROs, have to be used, where separate PRACH resources (e.g., time/frequency resources) are provided for 2-step ROs and 4-step ROs respectively. With that configuration option, each RO is configured for either 2-step RA or 4-step RA, but no RO is shared by both 2-step RA and 4-step RA. As an example of configuration of separate

ROs, there may for instance be N frequency multiplexed PRACH resources (i.e., occurring simultaneously but on different frequencies, e.g. different subcarriers), where M (M≤N) of these PRACH resources are associated with regular 4-step RA, while the remaining N−M PRACH resources are associated with 2-step RA.

C. MsgB Reception

Of special relevance to the present disclosure is the procedure the UE follows when receiving MsgB in 2-step RA.

After having transmitted msgA PUSCH, the UE starts a timer for a time window in which a response is expected, where this time window is referred to as the msgB window. The UE starts the MsgB window at the start of the first CORESET (in which the PDCCH is transmitted)—i.e. the first PDCCH monitoring occasion (for Type1-PDCCH)—occurring at least one symbol after the end of the msgA PUSCH transmission. This is more accurately expressed in chapter 8.2A in 3GPP TS 38.213 as follows:
“In response to a transmission of a PRACH and a PUSCH, or to a transmission of only a PRACH if the PRACH preamble is mapped to a valid PUSCH occasion, a UE attempts to detect a DCI format 1_0 with CRC scrambled by a corresponding MsgB-RNTI during a window controlled by higher layers [11, TS 38.321]. The window starts at the first symbol of the earliest CORESET the UE is configured to receive PDCCH for Type1-PDCCH CSS set, as defined in Clause 10.1, that is at least one symbol, after the last symbol of the PUSCH occasion corresponding to the PRACH transmission, where the symbol duration corresponds to the SCS for Type1-PDCCH CSS set. The length of the window in number of slots, based on the SCS for Type1-PDCCH CSS set, is provided by msgB-Response Window.”

During the MsgB window the UE monitors the PDCCH for a response to its msgA transmission. If the UE is in RRC_IDLE or RRC_INACTIVE state, the expected response is a msgB with a successRAR MAC sub-PDU or a fallbackRAR MAC sub-PDU intended for the UE. In the case of a successRAR, this means that the UE Contention Resolution ID in the successRAR matches the first 48 bits of the UE's msgA PUSCH transmission. In the case of a fallbackRAR, it means that the RAPID (Random Access Preamble ID) matches the preamble index of the preamble the UE transmitted in msgA.

The following is the relevant text for RAR response in the MAC specification 3GPP TS 38.321 version 16.1.0 (the content of chapter 5.1.4A “Random Access Response reception”):

“Once the MSGA preamble is transmitted, regardless of the possible occurrence of a measurement gap,
the MAC entity shall:

| 1> | start the msgB-ResponseWindow at the PDCCH occasion as specified in TS 38.213 [6], clause | |
|---|---|---|
| | 8.2A; | |
| 1> | monitor the PDCCH of the SpCell for a Random Access Response identified by MSGB-RNTI | |
| | while the msgB-ResponseWindow is running; | |
| 1> | if C-RNTI MAC CE was included in the MSGA: | |
| | 2> | monitor the PDCCH of the SpCell for Random Access Response identified by the C-RNTI |
| | | while the msgB-ResponseWindow is running. |
| 1> | if notification of a reception of a PDCCH transmission of the SpCell is received from lower layers: | |
| | 2> | if the C-RNTI MAC CE was included in MSGA: |

| | |
|---|---|
| 3> | if the Random Access procedure was initiated for SpCell beam failure recovery (as specified in |

| clause 5.17) and the PDCCH transmission is addressed to the C-RNTI: | |
|---|---|
| 4> | consider this Random Access Response reception successful; |
| 4> | stop the msgB-ResponseWindow; |
| 4> | consider this Random Access procedure successfully completed. |

| | |
|---|---|
| 3> | else if the timeAlignmentTimer associated with the PTAG is running: |

| | |
|---|---|
| 4> | if the PDCCH transmission is addressed to the C-RNTI and contains a UL grant for a new |

| transmission: | |
|---|---|
| 5> | consider this Random Access Response reception successful; |
| 5> | stop the msgB-ResponseWindow; |
| 5> | consider this Random Access procedure successfully completed. |

| | |
|---|---|
| 3> | else: |

| | |
|---|---|
| 4> | if a downlink assignment has been received on the PDCCH for the C-RNTI and the |

| received TB is successfully decoded: | |
|---|---|
| 5> | if the MAC PDU contains the Absolute Timing Advance Command MAC CE subPDU: |

| | |
|---|---|
| 6> | process the received Timing Advance Command (see clause 5.2); |
| 6> | consider this Random Access Response reception successful; |
| 6> | stop the msgB-ResponseWindow; |
| 6> | consider this Random Access procedure successfully completed and finish the |

disassembly and demultiplexing of the MAC PDU.

| | |
|---|---|
| 2> | if a valid (as specified in TS 38.213 [6]) downlink assignment has been received on the PDCCH |

| for the MSGB-RNTI and the received TB is successfully decoded: | |
|---|---|
| 3> | if the MSGB contains a MAC subPDU with Backoff Indicator: |

| | |
|---|---|
| 4> | set the PREAMBLE_BACKOFF to value of the BI field of the MAC subPDU using Table |

7.2-1, multiplied with SCALING_FACTOR_BI.

| | |
|---|---|
| 3> | else: |

| | |
|---|---|
| 4> | set the PREAMBLE_BACKOFF to 0 ms. |

| | |
|---|---|
| 3> | if the MSGB contains a fallbackRAR MAC subPDU; and |
| 3> | if the Random Access Preamble identifier in the MAC subPDU matches the transmitted |

| PREAMBLE_INDEX (see clause 5.1.3a): | |
|---|---|
| 4> | consider this Random Access Response reception successful; |
| 4> | apply the following actions for the SpCell: |

| 5> | process the received Timing Advance Command (see clause 5.2); |
|---|---|
| 5> | indicate the msgA-PreambleReceivedTargetPower and the amount of power ramping |
| | applied to the latest Random Access Preamble transmission to lower layers (i.e. |
| | (PREAMBLE_POWER_RAMPING_COUNTER−1) × |
| | PREAMBLE_POWER_RAMPING_STEP); |
| 5> | if the Random Access Preamble was not selected by the MAC entity among the |

| contention-based Random Access Preamble(s): | |
|---|---|
| 6> | consider the Random Access procedure successfully completed; |
| 6> | process the received UL grant value and indicate it to the lower layers. |

| | |
|---|---|
| 5> | else: |

| 6> | set the TEMPORARY_C-RNTI to the value received in the Random Access |
|---|---|
| | Response; |
| 6> | if the Msg3 buffer is empty: |

| | |
|---|---|
| 7> | obtain the MAC PDU to transmit from the MSGA buffer and store it in the |

Msg3 buffer;

| | |
|---|---|
| 6> | process the received UL grant value and indicate it to the lower layers and |

proceed with Msg3 transmission.

| NOTE: | | If within a 2-step RA type procedure, an uplink grant provided in the fallback RAR has a |
|---|---|---|
| | | different size than the MSGA payload, the UE behavior is not defined. |
| | 3> | else if the MSGB contains a successRAR MAC subPDU; and |
| | 3> | if the CCCH SDU was included in the MSGA and the UE Contention Resolution Identity in the |

| MAC subPDU matches the CCCH SDU: | |
|---|---|
| 4> | stop msgB-ResponseWindow; |
| 4> | if this Random Access procedure was initiated for SI request: |

| | |
|---|---|
| 5> | indicate the reception of an acknowledgement for SI request to upper layers. |

| | |
|---|---|
| 4> | else: |

| | |
|---|---|
| 5> | set the C-RNTI to the value received in the successRAR; |
| 5> | apply the following actions for the SpCell: |

| | |
|---|---|
| 6> | process the received Timing Advance Command (see clause 5.2); |
| 6> | indicate the msgA-PreambleReceivedTargetPower and the amount of power |

ramping applied to the latest Random Access Preamble transmission to lower
layers (i.e. (PREAMBLE_POWER_RAMPING_COUNTER−1) ×
PREAMBLE_POWER_RAMPING_STEP).

| 4> | deliver the TPC, PUCCH resource Indicator, ChannelAccess-CPext (if indicated), and |
|---|---|
| | HARQ feedback Timing Indicator received in successRAR to lower layers. |
| 4> | consider this Random Access Response reception successful; |
| 4> | consider this Random Access procedure successfully completed; |
| 4> | finish the disassembly and demultiplexing of the MAC PDU. |

| 1> | if msgB-ResponseWindow expires, and the Random Access Response Reception has not been | |
|---|---|---|
| | considered as successful based on descriptions above: | |
| | 2> | increment PREAMBLE_TRANSMISSION_COUNTER by 1; |
| | 2> | if PREAMBLE_TRANSMISSION_COUNTER = preambleTransMax + 1: |

| | |
|---|---|
| 3> | indicate a Random Access problem to upper layers; |
| 3> | if this Random Access procedure was triggered for SI request: |

| | |
|---|---|
| 4> | consider this Random Access procedure unsuccessfully completed. |

| | |
|---|---|
| 2> | if the Random Access procedure is not completed: |

| | |
|---|---|
| 3> | if msgA-TransMax is applied (see clause 5.1.1a) and |

| PREAMBLE_TRANSMISSION_COUNTER = msgA-TransMax + 1: | |
|---|---|
| 4> | set the RA_TYPE to 4-stepRA; |
| 4> | perform initialization of variables specific to Random Access type as specified in clause |
| | 5.1.1a; |
| 4> | if the Msg3 buffer is empty: |

| | |
|---|---|
| 5> | obtain the MAC PDU to transmit from the MSGA buffer and store it in the Msg3 buffer; |

| 4> | flush HARQ buffer used for the transmission of MAC PDU in the MSGA buffer; |
|---|---|
| 4> | discard explicitly signaled contention-free 2-step RA type Random Access Resources, if |
| | any; |
| 4> | perform the Random Access Resource selection procedure as specified in clause 5.1.2. |

| | |
|---|---|
| 3> | else: |

| 4> | select a random backoff time according to a uniform distribution between 0 and the |
|---|---|
| | PREAMBLE_BACKOFF; |
| 4> | if the criteria (as defined in clause 5.1.2a) to select contention-free Random Access |

| Resources is met during the backoff time: | |
|---|---|
| 5> | perform the Random Access Resource selection procedure for 2-step RA type Random |

Access (see clause 5.1.2a).

| | |
|---|---|
| 4> | else: |

| | |
|---|---|
| 5> | perform the Random Access Resource selection procedure for 2-step RA type Random |

Access (see clause 5.1.2a) after the backoff time.

Upon receiving a fallbackRAR, the MAC entity may stop msgB-ResponseWindow once the Random
Access Response reception is considered as successful.”

V. Satellite Communications and Non-Terrestrial Networks (NTN)

There is an ongoing resurgence of satellite communications. Several plans for satellite networks have been announced in the past few years. The target services vary, from backhaul and fixed wireless, to transportation, to outdoor mobile, to Internet of Things (IoT). Satellite networks could complement mobile networks on the ground by providing connectivity to underserved areas and multicast/broadcast services.

To benefit from the strong mobile ecosystem and economy of scale, adapting the terrestrial wireless access technologies including LTE and NR for satellite networks is drawing significant interest. For example, 3GPP completed an initial study in Release 15 on adapting NR to support non-terrestrial networks (mainly satellite networks) (TR 38.811, Study on New Radio (NR) to support non-terrestrial networks) (hereinafter “TR 38.811”). This initial study focused on the channel model for the non-terrestrial networks, defining deployment scenarios, and identifying the key potential impacts. 3GPP is conducting a follow-up study item in Release 16 on solutions evaluation for NR to support non-terrestrial networks (RP-181370, Study on solutions evaluation for NR to support non-terrestrial networks) (hereinafter “RP-181370”).

A satellite radio access network usually includes the following components:
Gateway that connects satellite network to core network.
Satellite that refers to a space-borne platform.
Terminal that refers to user equipment.
Feeder link that refers to the link between a gateway and a satellite.
Service link that refers to the link between a satellite and a terminal.

The link from gateway to terminal is often called forward link, and the link from terminal to gateway is often called return link or access link. Depending on the functionality of the satellite in the system, we can consider two transponder options
Bent pipe transponder (also referred to as transparent satellite or transparent payload): satellite forwards the received signal back to the earth with only amplification and a shift from uplink frequency to downlink frequency.
Regenerative transponder (also referred to as regenerative satellite or regenerative payload): satellite includes on-board processing to demodulate and decode the received signal and regenerate the signal before sending it back to the earth.

Depending on the orbit altitude, a satellite may be categorized as Low Earth Orbit (LEO), Medium Earth Orbit (MEO), or Geostationary Earth Orbit (GEO) satellite.
LEO: typical heights ranging from 250-1,500 km, with orbital periods ranging from 90-130 minutes.
MEO: typical heights ranging from 5,000-25,000 km, with orbital periods ranging from 2-14 hours.
GEO: height at about 35,786 km, with an orbital period of 24 hours.

A communication satellite typically generates several beams over a given area. The footprint of a beam is usually in an elliptic shape, which has been traditionally considered as a cell, but cells consisting of the coverage footprint of multiple beams are excluded. The footprint of a beam is also often referred to as a spotbeam. The footprint of a beam may move over the earth surface with the satellite movement or may be earth fixed with some beam pointing mechanism used by the satellite to compensate for its motion. The size of a spotbeam depends on the system design, which may range from tens of kilometers to a few thousands of kilometers. FIG. 5 shows an example architecture of a satellite network with bent pipe transponders.

In RAN #80, a new study item “Solutions for NR to support Non-Terrestrial Network” was agreed (RP-181370). It is a continuation of a preceding study item “NR to support Non-Terrestrial Networks” (RP-171450), where the objective was to study the channel model for the non-terrestrial networks, to define deployment scenarios and parameters, and to identify the key potential impacts on NR. The results are reflected in 3GPP TR 38.811.

The objectives of the current study item are to evaluate solutions for the identified key impacts from the preceding study item and to study impact on RAN protocols/architecture. The objectives for layer 2 and above are:

| • | Study the following aspects and identify related solutions if | |
|---|---|---|
| | needed: Propagation delay: Identify timing requirements and | |
| | solutions on layer 2 aspects, MAC, RLC, RRC, to support | |
| | non-terrestrial network propagation delays considering FDD | |
| | and TDD duplexing mode. This includes radio link | |
| | management. [RAN2] | |
| • | Handover: Study and identify mobility requirements and | |
| | necessary measurements that may be needed for handovers | |
| | between some non-terrestrial space-borne vehicles (such | |
| | as Non-Geo stationary satellites) that move at much higher | |
| | speed but over predictable paths [RAN2, RAN1] | |
| • | Architecture: Identify needs for the 5G's Radio Access | |
| | Network architecture to support non-terrestrial networks | |
| | (e.g. handling of network identities) [RAN3] | |
| | • | Paging: procedure adaptations in case of moving satellite |
| | | foot prints or cells |
| Note: | | |

| | |
|---|---|
| • | This new study item does not address regulatory issues. |

The coverage pattern of NTN is described in 3GPP TR 38.811 in Section 4.6 as follows:
Satellite or aerial vehicles typically generate several beams over a given area. The foot print of the beams are typically elliptic shape.
The beam footprint may be moving over the earth with the satellite or the aerial vehicle motion on its orbit. Alternatively, the beam foot print may be earth fixed, in such case some beam pointing mechanisms (mechanical or electronic steering feature) will compensate for the satellite or the aerial vehicle motion.

TABLE 4.6-1
Typical beam footprint size

| Attributes | GEO | Non-GEO | Aerial |
|---|---|---|---|
| 1) Beam foot print | 2) 200-1000 km | 3) 100-500 km | 4) 5-200 km |
| size in diameter | | | |

Typical beam patterns of various NTN access networks are depicted in FIG. 6.

The TR of the ongoing study item, 3GPP TR 38.821, describes scenarios for the NTN work as follows:

Non-Terrestrial Network typically features the following elements [3]:
One or several sat-gateways that connect the Non-Terrestrial Network to a public data network
   a GEO satellite is fed by one or several sat-gateways which are deployed across the satellite targeted coverage (e.g. regional or even continental coverage). We assume that UE in a cell are served by only one sat-gateway
   A Non-GEO satellite served successively by one sat-gateway at a time. The system ensures service and feeder link continuity between the successive serving sat-gateways with sufficient time duration to proceed with mobility anchoring and hand-over
      Four scenarios are considered as depicted in Table 4.2-1 and are detailed in Table 4.2-2 [3].

TABLE 4.2-1
Reference scenarios

| | Transparent | Regenerative |
|---|---|---|
| | satellite | satellite |
| GEO based non-terrestrial access network | Scenario A | Scenario B |
| LEO based non-terrestrial access network | Scenario C | Scenario D |

TABLE 4.2-2
Reference scenario parameters

| | GEO based non-terrestrial access | LEO based non-terrestrial |
|---|---|---|
| Scenarios | network (Scenario A and B) | access network (Scenario C & D) |
| Orbit type | Notional station keeping position | Circular orbiting around the |
| | fixed in terms of elevation/azimuth | earth |
| | with respect to a given earth point | |
| Altitude | 35,786 km | 600 km |
| | | 1,200 km |
| Spectrum | <6 GHz (e.g. 2 GHz) | |
| (service link) | >6 GHz (e.g. DL 20 GHz, UL 30 GHz) | |
| Max channel | 30 MHz for band <6 GHz | |
| bandwidth | 400 MHz for band >6 GHz | |
| (service link) | | |
| Payload | Scenario A: Transparent (including | Scenario C: Transparent |
| | radio frequency function only) | (including radio frequency |
| | Scenario B: regenerative (including | function only) |
| | all or part of RAN functions) | Scenario D: Regenerative |
| | | (including all or part of RAN |
| | | functions) |
| Inter-Satellite | No | Scenario C: No |
| link | | Scenario D: Yes |
| Earth-fixed beams | Yes | Scenario C: No (the beams |
| | | move with the satellite) |
| | | Scenario D, option 1: Yes |
| | | (steering beams), see note 1 |
| | | Scenario D, option 2: No (the |
| | | beams move with the satellite) |
| Max beam foot | 500 km | 200 km |
| print diameter | | |
| at nadir | | |
| Min Elevation | 10° | 10° |
| angle for both | | |
| sat-gateway and | | |
| user equipment | | |
| Max distance | 40,586 km | 1,932 km (600 km altitude) |
| between satellite | | 3,131 km (1,200 km altitude) |
| and user equipment | | |
| at min elevation | | |
| angle | | |
| Max Round Trip | Scenario A: 562 ms (service | Scenario C: 25.76 ms (transparent |
| Delay | and feeder links) | payload: service and feeder links) |
| (propagation | Scenario B: 281 ms | Scenario D: 12.88 ms (regenerative |
| delay only) | | payload: service link only) |
| Max delay variation | 16 ms | 4.44 ms (600 km) |
| within a beam | | 6.44 ms (1200 km) |
| (earth fixed user | | |
| equipment) | | |
| Max differential | 1.6 ms | 0.65 ms (*) |
| delay within a beam | | |
| Max Doppler shift | 0.93 ppm | 24 ppm (*) |
| (earth fixed | | |
| user equipment) | | |
| Max Doppler shift | 0.000 045 ppm/s | 0.27 ppm/s (*) |
| variation | | |
| (earth fixed user | | |
| equipment) | | |
| User equipment | 1000 km/h (e.g. aircraft) | 500 km/h (e.g. high speed train) |
| motion on the earth | | Possibly 1000 km/h (e.g. aircraft) |
| User equipment | Omnidirectional antenna (linear polarisation), assuming 0 dBi | |
| antenna types | Directive antenna (up to 60 cm equivalent aperture diameter in | |
| | circular polarisation) | |
| User equipment | Omnidirectional antenna: UE power class 3 with up to 200 mW | |
| Tx power | Directive antenna: up to 4 W | |
| User equipment | Omnidirectional antenna: 7 dB | |
| Noise figure | Directive antenna: 1.2 dB | |
| Service link | 3GPP defined New Radio | |
| Feeder link | 3GPP or non-3GPP defined Radio | 3GPP or non-3GPP defined Radio |
| | interface | interface |

NOTE 1:
Each satellite has the capability to steer beams towards fixed points on earth using beamforming techniques. This is applicable for a period of time corresponding to the visibility time of the satellite
NOTE 2:
Max delay variation within a beam (earth fixed user equipment) is calculated based on Min Elevation angle for both gateway and user equipment
NOTE 3:
Max differential delay within a beam is calculated based on Max beam foot print diameter at nadir

For scenario D, which is LEO with regenerative payload, both earth-fixed and earth moving beams have been listed. So, when we factor in the fixed/non-fixed beams, we have an additional scenario. The complete list of 5 scenarios in 3GPP TR 38.821 (TR 38.821, Study on solutions evaluation for NR to support non-terrestrial networks) is then:
Scenario A—GEO, transparent satellite, Earth-fixed beams;
Scenario B—GEO, regenerative satellite, Earth fixed beams;
Scenario C—LEO, transparent satellite, Earth-moving beams;
Scenario D1—LEO, regenerative satellite, Earth-fixed beams; and
Scenario D2—LEO, regenerative satellite, Earth-moving beams.

When NR or LTE is applied to provide the connectivity via satellites, it means that the ground station is a RAN node. In the case where the satellite is transparent, all RAN functionalities are on the ground which means the sat-gateway has whole eNB/gNB functionality. For the regenerative satellite payload, part or all, of the eNB/gNB processing may be on the satellite.

### SUMMARY

Embodiments of Random Access Response (RAR) window definitions, which are designed for a system such as a Non-Terrestrial Network (NTN). In one embodiment, a method performed by a User Equipment (UE) for random access to a RAN of a cellular communications system comprises transmitting a first random access transmission in a Physical Random Access Channel (PRACH) occasion, the first random access transmission being either a random access preamble or a MsgA; determining a reference symbol for a start of a response window, the response window being either a RAR window or a MsgB response window; and monitoring for a response during the response window, the start of the response window being defined relative to the reference symbol. Embodiments of the solution disclosed herein eliminate the problems associated with the current RAR window timing definition, when applied in an NTN, where the round-trip times are far greater than the UE can ever experience in a terrestrial network.

In one embodiment, determining the reference symbol comprises determining the reference symbol based on an uplink symbol related to the PRACH occasion in which a first random access response transmission was transmitted.

In one embodiment, the uplink symbol related to the PRACH occasion in which the first random access response transmission was transmitted is a last uplink symbol of the PRACH occasion in which the first random access response transmission was transmitted.

In one embodiment, determining the reference symbol comprises determining the reference symbol based on an assumed timing advance of zero.

In one embodiment, determining the reference symbol comprises determining the reference symbol as

$$⌊ n \cdot \frac{{2}^{{μ}_{DL}}}{{2}^{{μ}_{UL}}} ⌋ ,$$

where n is the uplink symbol related to the PRACH occasion, μ_{DL} is the downlink subcarrier spacing, and μ_{UL} is the uplink subcarrier spacing.

In one embodiment, the reference symbol is a downlink symbol having a same frame number, slot number, and symbol number as a last uplink symbol of the PRACH occasion in which the first random access transmission was transmitted.

In one embodiment, the reference symbol is a downlink symbol having a same frame number, slot number, and symbol number as a last uplink symbol of the PRACH occasion in which the first random access transmission was transmitted.

In one embodiment, determining the reference symbol comprises determining the reference symbol based on an assumed timing advance of zero.

In one embodiment, uplink and downlink in the RAN share a common timing structure.

In one embodiment, the RAN comprises an NTN.

In one embodiment, a cell to which the UE is performing random access is a cell served by a non-terrestrial base station.

In one embodiment, the start of the response window is a start of a first Physical Downlink Control Channel (PDCCH) monitoring occasion occurring at least one symbol after the reference symbol.

In one embodiment, there is at least one symbol gap between the reference symbol and the start of the response window.

In one embodiment, the start of the response window is a symbol occurring immediately after the reference symbol.

In one embodiment, a minimum symbol gap between the reference symbol and the start of the response window is configurable.

In one embodiment, a minimum symbol gap between the reference symbol and the start of the response window is a function of symbol duration.

In one embodiment, a minimum symbol gap between the reference symbol and the start of the response window is a function of subcarrier spacing.

In one embodiment, the start of the response window is aligned with a start of a PDCCH monitoring occasion.

In one embodiment, the start of the response window is independent of PDCCH monitoring occasions.

In one embodiment, a wireless communication device is adapted to transmit a first random access transmission in a Physical Random Access Channel (PRACH) occasion, the first random access transmission being either a random access preamble or a MsgA; determine a reference symbol for a start of a response window, the response window being either a RAR window or a MsgB response window; and monitor for a response during the response window, the start of the response window being defined relative to the reference symbol.

In one embodiment, a wireless communication device comprises one or more transmitters; one or more receivers; and processing circuitry associated with the one or more transmitters and the one or more receivers, the processing circuitry configured to cause the wireless communication device to transmit a first random access transmission in a Physical Random Access Channel (PRACH) occasion, the first random access transmission being either a random access preamble or a MsgA; determine a reference symbol for a start of a response window, the response window being either a RAR window or a MsgB response window; and monitor for a response during the response window, the start of the response window being defined relative to the reference symbol.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a four-step random access approach used for New Radio (NR) Rel-15;

FIG. 2 illustrates an example of Physical Random Access Channel (PRACH) occasion configuration in NR;

FIG. 3 illustrates a two-step random access approach used for NR Rel-16;

FIG. 4 illustrates timing and latency differences between the four-step approach and the two-step approach;

FIG. 5 illustrates an example architecture of a satellite network with bent pipe transponders;

FIG. 6 illustrates examples of Non-Terrestrial Network (NTN) beam patterns;

FIG. 7 illustrates an example of a wireless communications system, according to some embodiments of the present disclosure;

FIG. 8 illustrates an example of a wireless communication system in which at least part of a Radio Access Network (RAN) is an NTN;

FIG. 9 illustrates Timing Advance (TA) components in the NTN;

FIG. 10 illustrates an example of a timing of a Random Access Response (RAR) window, according to some embodiments of the present disclosure;

FIG. 11 illustrates a flow chart of an operation of a User Equipment (UE), according to some embodiments of the present disclosure;

FIG. 12 is a schematic block diagram of a radio access node according to some embodiments of the present disclosure;

FIG. 13 is a schematic block diagram that illustrates a virtualized embodiment of the radio access node according to some embodiments of the present disclosure;

FIG. 14 is a schematic block diagram of the radio access node according to some other embodiments of the present disclosure;

FIG. 15 is a schematic block diagram of a wireless communication device according to some embodiments of the present disclosure;

FIG. 16 is a schematic block diagram of the wireless communication device according to some other embodiments of the present disclosure;

FIG. 17 a communication system includes a telecommunication network, such as a Third Generation Partnership Project (3GPP)-type cellular network, which comprises an access network, such as a RAN, and a core network according to some embodiments of the present disclosure;

FIG. 18 illustrates a communication system including a host computer according to some embodiments of the present disclosure; and

FIGS. 19-22 are flowcharts illustrating methods implemented in a communication system, according to some embodiments of the present disclosure.

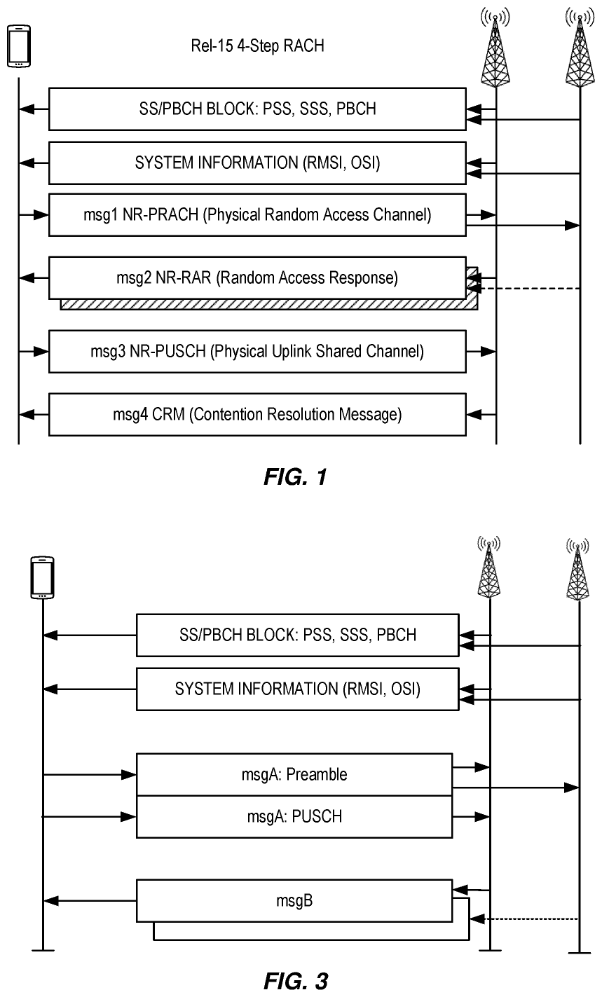

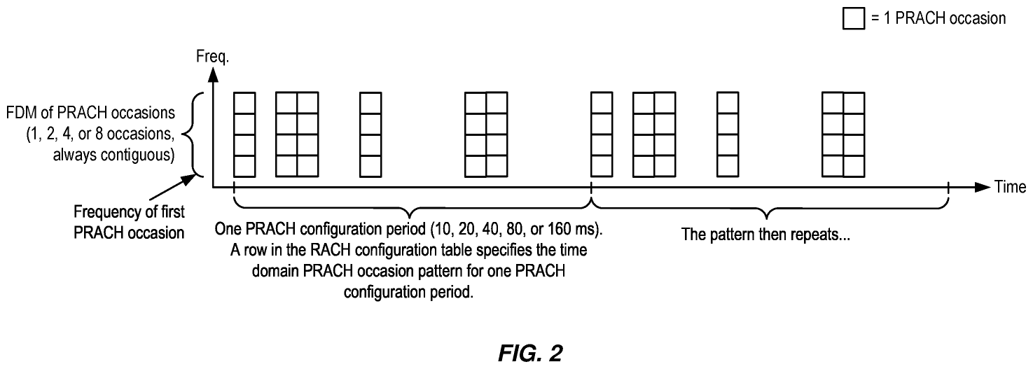

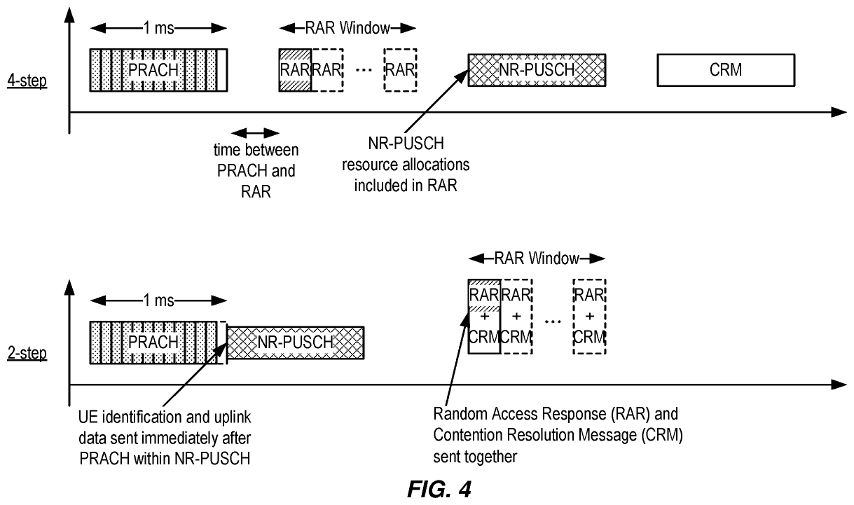

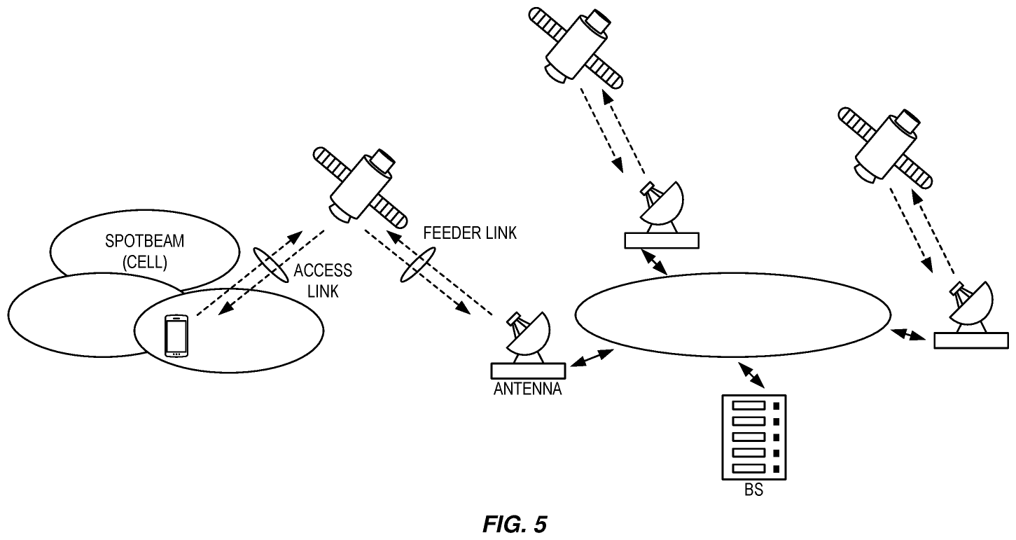

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Note that, in this description, the terms “Random Access Response (RAR) window,” “RAR window,” and “RAR response window” are considered equivalent. Similarly, the terms “Message (Msg) B window,” “MsgB window,” and “MsgB response window” are considered equivalent. In addition, the terms (or abbreviations) “msg1” and “Msg1”, “msg2” and “Msg2”, “msg3” and “Msg3”, “msgA” and “MsgA”, as well as “msgB” and “MsgB” are pairwise respectively interchangeable.

In Non-Terrestrial Networks (NTNs), the propagation delay—and consequently also the Round-Trip Time (RTT)—between the gNB and the UE (and vice versa) is much greater than in terrestrial networks, e.g. propagation delays in the order of tens or hundreds of milliseconds, depending on NTN scenario, while the propagation delay in a cell in a terrestrial network is typically below 10 microseconds.

This circumstance makes the RAR window defined for terrestrial networks suboptimal. The UE will start to monitor the downlink much earlier than the RAR can possibly arrive at the earliest. Even worse is that the UE may stop monitoring the downlink prematurely because of RAR window expiration (and determine that RAR reception failed), and may thus miss a RAR, because the UE and the network are not synchronized with regards to the RAR window.

Certain aspects of the present disclosure and their embodiments may provide solutions to the aforementioned or other challenges. The proposed solution leverages the observation that the RAR window is a downlink concept in the sense that it concerns the reception of the RAR, which is a message transmitted in the downlink. Hence, the root of the problem is that the RAR window is currently defined in relation to the Physical Random Access Channel (PRACH) occasion, which is a concept associated with the uplink. As mentioned above, this works in a terrestrial network with its short round-trip times, but as explained above, it is detrimental in an NTN.

To this end, one aspect of the proposed solution is to tie the definition of the start of the RAR window to the downlink. This comprises changing the time reference for the start of the RAR window from the uplink (as in the currently specified definition) to the downlink (as in the proposed solution). To achieve this conceptual shift, the solution leverages the common time structure (i.e., the frame/slot/symbol structure) of the downlink and the uplink. To this end, the UE identifies the frame/slot/symbol number of the end of the PRACH occasion (which would be the time reference for the RAR window definition according to the current specifications) and uses the corresponding downlink symbol, i.e. the downlink symbol with the same frame/slot/symbol number, as the time reference for the definition of the start of the RAR window. This way, the long RTT of NTNs is automatically accounted for.

The same principle solution may be applied also to the definition of the MsgB response window as well as the start of the contention resolution timer.

Certain embodiments may provide one or more of the following technical advantage(s). Embodiments of the solution disclosed herein eliminate the problems associated with the current RAR window timing definition, when applied in an NTN, where the round-trip times are far greater than the UE can ever experience in a terrestrial network. By a conceptual change of the definition, the long round-trip time is automatically accounted for, thereby eliminating the potential lack of RAR window synchronization between the UE and the gNB and making the RAR window well adapted to the potential arrival times of RAR messages at the UE.

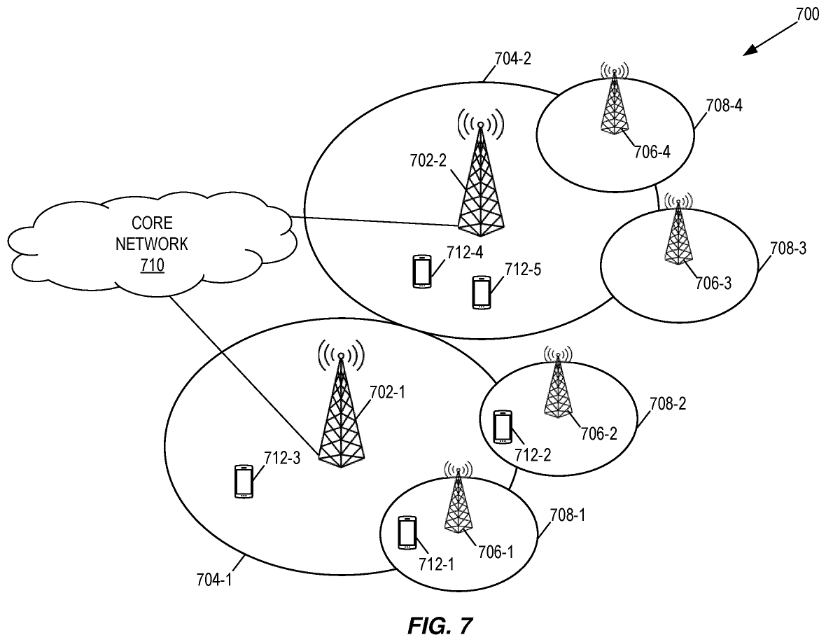

FIG. 7 illustrates one example of a cellular communications system 700 in which embodiments of the present disclosure may be implemented. In the embodiments described herein, the cellular communications system 700 is a 5G system (5GS) including a Next Generation RAN (NG-RAN) and a 5G Core (5GC); however, embodiments of the solution disclosed herein are not limited thereto. In this example, the RAN includes base stations 702-1 and 702-2, which in the 5GS include NR base stations (gNBs) and optionally next generation eNBs (ng-eNBs) (e.g., LTE RAN nodes connected to the 5GC), controlling corresponding (macro) cells 704-1 and 704-2. The base stations 702-1 and 702-2 are generally referred to herein collectively as base stations 702 and individually as base station 702. Likewise, the (macro) cells 704-1 and 704-2 are generally referred to herein collectively as (macro) cells 704 and individually as (macro) cell 704. The RAN may also include a number of low power nodes 706-1 through 706-4 controlling corresponding small cells 708-1 through 708-4. The low power nodes 706-1 through 706-4 can be small base stations (such as pico or femto base stations) or Remote Radio Heads (RRHs), or the like. Notably, while not illustrated, one or more of the small cells 708-1 through 708-4 may alternatively be provided by the base stations 702. The low power nodes 706-1 through 706-4 are generally referred to herein collectively as low power nodes 706 and individually as low power node 706. Likewise, the small cells 708-1 through 708-4 are generally referred to herein collectively as small cells 708 and individually as small cell 708. The cellular communications system 700 also includes a core network 710, which in the 5G System (5GS) is referred to as the 5GC. The base stations 702 (and optionally the low power nodes 706) are connected to the core network 710.

The base stations 702 and the low power nodes 706 provide service to wireless communication devices 712-1 through 712-5 in the corresponding cells 704 and 708. The wireless communication devices 712-1 through 712-5 are generally referred to herein collectively as wireless communication devices 712 and individually as wireless communication device 712. In the following description, the wireless communication devices 712 are oftentimes UEs, but the present disclosure is not limited thereto.

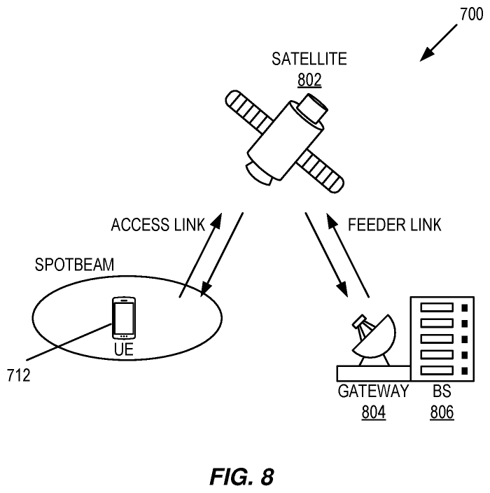

FIG. 8 illustrates one example of the wireless communication system 700 in which at least part of the RAN is an NTN (i.e., wherein at least one of the base stations 802 is an NTN base station, which may be referred to herein as an example a gNB in an NTN or an NTN gNB). As illustrated, the wireless communication system 800 includes a NTN, which includes, in this example, a satellite 802 (i.e., a space or airborne radio access node or platform) and one or more gateways 804 that interconnect the satellite 802 to a land-based base station component 806. The functionality of a base station 802 described herein may be implemented in the satellite 802 or distributed between the satellite 802 and the land-based base station component 806 (e.g., the satellite 802 may implement L1 functionality and the land-based base station component 806 may implement L2 and L3 functionality). In this example, the UE 712 communicates with the NTN via the satellite 802. Note that the wireless communication system 700 is only one example of a wireless communication system that utilizes an NTN for radio access. The embodiments disclosed here are equally applicable to any such system.

Now, a description of some example embodiments of the present disclosure is provided.

The specification of the start of the RAR window in relation to the PRACH occasion is appropriate in a terrestrial network, where the round-trip time is typically less than the duration of a symbol. However, in an NTN, this RAR window start is far too early and the RAR window will both start and end in less than a round-trip time and thus before any RAR has had a chance to arrive to the UE 712.

With the proposed solution, the observation that the RAR window is a downlink concept in the sense that it concerns the reception of the RAR, which is a message transmitted in the downlink, is leveraged. Hence, the root of the problem is that the RAR window is currently defined in relation to the PRACH occasion, which is a concept associated with the uplink. As mentioned above, this works in a terrestrial network with its short round-trip times, but as explained above, it is detrimental in an NTN.

To this end, one aspect of the proposed solution is to tie the definition of the start of the RAR window to the downlink.

Another thing to consider is that the circumstances for Timing Advance (TA) are different in NTNs than in terrestrial networks. In an NTN, the UE can never be close to the gNB antenna, which means that the smallest possible correct TA is much greater than 0. Hence, the TA will vary in a span, depending on the UE's location in the cell, which starts at a value greater than 0 and where the span is typically smaller than the smallest TA (i.e., typically TAₘₐₓ−TAₘᵢₙ<TAₘᵢₙ).

In the study phase for NTN, 3GPP identified two different main ways for TA derivation. As one option, the UE can calculate the TA itself, based on knowledge of its own location (obtained from Global Navigation Satellite System (GLASS) measurements), ephemeris data (i.e., information about a satellite's orbit and position) and the TA valid at a reference position in the cell, as indicated by the gNB (which takes into account the possible additional delay incurred by the feeder link between the gNB at the ground and the satellite in the bent-pipe/transparent architecture). Any additional TA refinements, if needed, can be provided using the existing dynamic TA adjustment signaling (i.e., TA signaling in the RAR and TA adjustments using the Timing Advance Command Medium Access Control (MAC) Control Element (CE)).

As another option, the network is in full control (i.e., there is no UE autonomously calculated part of the TA) and the difference between the cell-common TA (valid at a signaled reference point in the cell, as described above) is accounted for using dynamic TA adjustment signaling (i.e. TA signaling in the RAR and TA adjustments using the Timing Advance Command MAC Control Element).

These TA management alternatives are captured as follows in chapter 6.3.4 in 3GPP TR 38.821 version 16.0.0 (which was written during the NTN study item phase):

“With consideration on the larger cell coverage, long round trip time (RTT) and high Doppler, enhancements are considered to ensure the performance for timing and frequency synchronization for UL transmission.

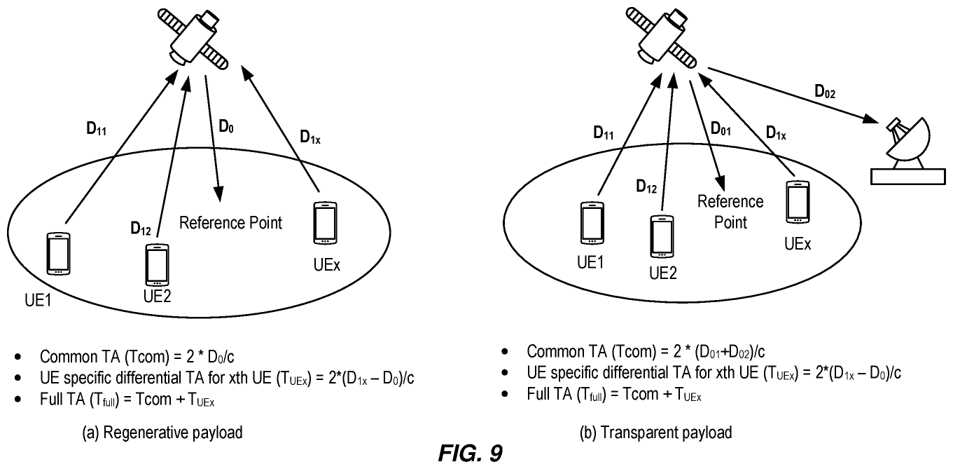

### Reproduced Herein as FIG. 9

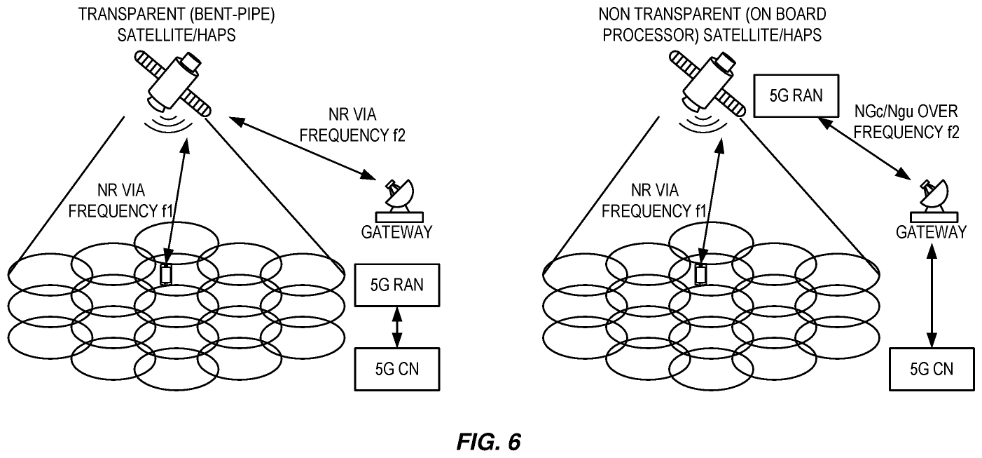

FIG. 6.3.4-1: Illustration of the TA components in NTN (For simplicity, TA offset N_{TA offset} is not plotted.)

For the timing advance (TA) in the initial access and the subsequent TA maintenance, the following solutions are identified with an illustration of the definition of terminology given in FIG. 6.3.4-1:

Option 1: Autonomous Acquisition of the TA at UE with UE Known Location and Satellite Ephemeris.
In this way, the required TA value for UL transmission including PRACH can be calculated by the UE. The corresponding adjustment can be done, either with UE-specific differential TA or full TA (consisting of UE specific differential TA and common TA).
W.r.t the full TA compensation at the UE side, both the alignment on the UL timing among UEs and DL and UL frame timing at network side can be achieved. However, in case of satellite with transparent payload, further discussion on how to handle the impact introduced by feeder link will be conducted in normative work. Additional needs for the network to manage the timing offset between the DL and UL frame timing can be considered, if impacts introduced by feeder link is not compensated by UE in corresponding compensation.
W.r.t the UE specific differential TA only, additional indication on a single reference point should be signaled to UEs per beam/cell for achieving the UL timing alignment among UEs within the coverage of the same beam/cell. Timing offset between DL and UL frame timing at the network side should also be managed by the network regardless of the satellite payload type.
With concern on the accuracy on the self-calculated TA value at the UE side, additional TA signaling from network to UE for TA refinement, e.g., during initial access and/or TA maintenance, can be determined in the normative work.

Option 2: Timing advanced adjustment based on network indication
In this way, the common TA, which refers to the common component of propagation delay shared by all UEs within the coverage of same satellite beam/cell, is broadcasted by the network per satellite beam/cell. The calculation of this common TA is conducted by the network with assumption on at least a single reference point per satellite beam/cell.
The indication for UE-specific differential TA from network as the Rel-15 TA mechanism is also needed. For satisfying the larger coverage of NTN, extension of value range for TA indication in RAR, either explicitly or implicitly, is identified. Whether to support negative TA value in corresponding indication will be determined in the normative phase.
Moreover, indication of timing drift rate, from the network to UE, is also supported to enable the TA adjustment at UE side.
   For calculation of common TA in the above two options, single reference point per beam is considered as the baseline. Whether and how to support the multiple reference points can be further discussed in the normative work.”

To improve the random access procedure, the UE can use the UE autonomously calculated TA or the common TA provided by the network when transmitting the random access preamble (i.e., Msg1). In the herein proposed solution, it is preferred that the UE in this way compensates for the major part of the RTT by applying a full TA (derived in either of the above ways) to the random access preamble transmission (wherein this TA can subsequently be refined through instructions from the network as usual).

Returning now to the solution concept of tying the RAR window definition (in particular the start of the RAR window) to the downlink, it can be noted that it is still reasonable to have a relation to the PRACH occasion used by the UE since it is the random access preamble transmission in this PRACH occasion that triggers the UE to expect a RAR from the network. This is achieved through the mutual timing structure of the downlink and the uplink, i.e. the division into (and numbering of) frames (and subframes), slots and symbols. Note that from the UE's perspective, the downlink and uplink are time shifted such that a certain frame/slot/symbol number occurs earlier in the uplink than the same frame/slot/symbol number in the downlink, due to the TA applied by the UE in the uplink.

To shift the current definition of the start of the RAR window (as per chapter 8.2 in 3GPP TS 38.213, as quoted above in section 2.1.3.3) from an uplink associated definition to a downlink associated definition, this downlink/uplink-common time structure is utilized. To this end, the UE takes the frame number, slot number, and symbol number of the last symbol of the used PRACH occasion in the uplink and identifies the symbol with the same frame number, slot number, and symbol number in the downlink. This symbol will be the time reference for the start of the RAR window (and is henceforth also referred to as the reference symbol), such that, similar to the current definition, the RAR window will start at the start of the first Physical Downlink Control Channel (PDCCH) monitoring occasion (for Type1-PDCCH) occurring at least one symbol after the reference symbol. This means that there is at least one symbol gap between the reference symbol and the start of the RAR window, but as an option, this minimum gap may be omitted (through configuration or specification), i.e. the RAR window may start in the symbol occurring immediately after the reference symbol. As another option, the minimum gap between the reference symbol and the start of the RAR window may be configured (or specified) to be larger than one symbol, e.g. 2, 3, 4, 5, 6, 7 or 8 symbols. As yet another option, this minimum gap may depend on the symbol duration (as derived from the Subcarrier Spacings (SCS)), e.g. configuring or specifying a gap of N symbols where N=2 for μ=0 or μ=1, N=4 for μ=2 or μ=3, and μ represents the SCS configuration, such that the SCS is 2^{μ}×15 kHz (i.e. μ=0⇒SCS=15 kHz, μ=1⇒SCS=30 kHz, μ=2⇒SCS=60 kHz, μ=3⇒SCS=120 kHz). In all the above options, the start of the RAR window should still preferably be tied to the start of a PDCCH monitoring occasion (for Type1-PDCCH) (i.e., the gap between the reference symbol and the start of the RAR window may be longer than the minimum gap), but as another alternative, the start of the RAR window may be independent of PDCCH monitoring occasions and instead only be determined by the reference symbol and the configured or specified gap.

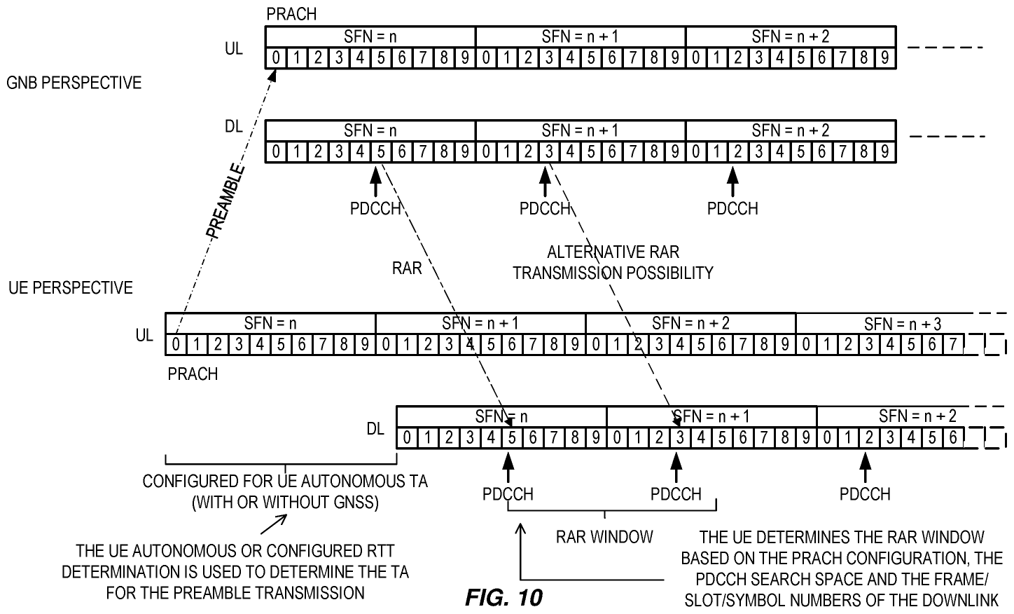

One example of an embodiment of the proposed solution is illustrated in FIG. 10. In particular, FIG. 10 is an illustration of the timing of the RAR window in accordance with the proposed solution. In FIG. 10, the UE is assumed to apply a TA (derived in either of the previously described ways) when calculating the PRACH occasion and transmitting the Random Access (RA) preamble.

A corresponding solution can be applied to the MsgB response window used in the 2-step RA procedure. In this case, the reference symbol (used as the time reference for the definition of the timing—in particular the start—of the MsgB window is the downlink symbol with the same frame/slot/symbol number as the last symbol of the Physical Uplink Shared Channel (PUSCH) occasion associated with the random access preamble and PRACH occasion used by the UE. I.e. the MsgB window starts at the start of the first PDCCH monitoring occasion (for Type1-PDCCH) occurring at least one symbol after the reference symbol. And just like described for the case of the RAR window about, additional options are that instead of a one-symbol minimum gap between the reference symbol and the start of the MsgB window, the minimum gap may be configured or specified to be 0, 2, or more symbol(s). And just like in the solution for the RAR window, in all options, the start of the MsgB window should preferably be tied to the start of a PDCCH monitoring occasion (for Type1-PDCCH) (i.e., the gap between the reference symbol and the start of the MsgB window may be longer than the minimum gap), but as another alternative, the start of the MsgB window may be independent of PDCCH monitoring occasions and instead only be determined by the reference symbol and the configured or specified gap.

Yet another application for the principles of the proposed solution is the start of the contention resolution timer. According to the current specifications, the UE starts this timer in the symbol following the UE's transmission of Msg3 (which makes the timer applicable for 4-step RA and fallback from 2-step RA to 4-step RA). Applying the principles of the proposed solution, as described above, means that the UE should instead start the contention resolution timer at the time of the downlink symbol (from the UE's perspective) with the same frame/slot/symbol number as the reference symbol following the Msg3 transmission in the uplink, or at the start of the first PDCCH monitoring occasion (for Type1-PDCCH) occurring at least one symbol after the reference symbol if such a gap exists.

The concept of reference symbol can be implemented in different ways. One option is to assume a logical TA=0, by which the downlink and uplink timing were as if they were not time shifted, although they are shifted due to the actual TA>0. In other words, for determining the downlink (DL) timing for a DL reference frame/slot/symbol corresponding to a referred uplink (UL) frame/slot/symbol, it is assumed TA=0. Another option is to specify the timing relationship using explicit frame/slot/symbol numbering. For example, for a referred UL slot n with SCS μ_{UL}, the DL reference slot with SCS μ_{DL} is

$$⌊ n \cdot \frac{{2}^{{μ}_{DL}}}{{2}^{{μ}_{UL}}} ⌋ ,$$

where it is assumed that TA=0 in such type of explicit slot numbering. As yet another option (previously described), the reference symbol in the downlink is the symbol with the same frame, slot and symbol number as the corresponding reference symbol in the downlink. For instance, if the reference symbol should correspond to the last symbol of the used PRACH occasion in the uplink, and this uplink symbol has the numbers SFN=x, slot number=y, symbol number=z, then the reference symbol in the downlink is the symbol which has the corresponding numbers, i.e. SFN=x, slot number=y, symbol number=z. (Note that this applies only within the corresponding SFN cycle.)

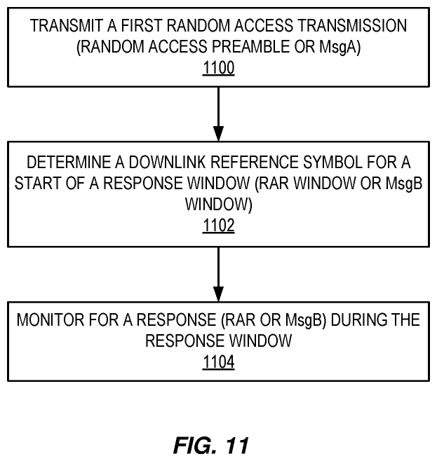

FIG. 11 is a flow chart that illustrates the operation of the UE 712 in accordance with at least some aspects of the embodiments described above. As illustrated, the UE 712 transmits a first random access transmission in a particular PRACH occasion (step 1100). In one embodiment, the random access transmission is a random access preamble (e.g., a RACH preamble). For instance, in this case, the random access procedure may be a 4-step random access procedure. In another embodiment, the first random access transmission is a MsgA of a 2-step random access procedure. As discussed above, in one embodiment, a TA estimate is preferably used by the UE 712 when transmitting the first random access transmission, especially if the respective base station 802 to which random access is being performed is part of an NTN. The TA estimate may, for example, be autonomously determined by the UE 712 or obtained from the network, as described above.

The UE 712 determines a reference symbol in the downlink (referred to herein as a “reference symbol” or a “downlink reference symbol”) for a start of a response window (step 1102). In the first random access transmission is a random access preamble, then the monitoring window is a RAR window. If the first random access transmission is a MsgA, then the monitoring window is a MsgB window.

As discussed above, in one embodiment, wherein determining the reference symbol comprises determining the reference symbol based on an uplink symbol related to the PRACH occasion in which the first random access response transmission was transmitted. In one embodiment, the uplink symbol related to the PRACH occasion in which the first random access response transmission was transmitted is a last uplink symbol of the PRACH occasion in which the first random access response transmission was transmitted. In some embodiments, the UE 712 determines the reference symbol based on the uplink symbol related to the PRACH occasion based on an assume TA=0. In one embodiment, the UE 712 determines the reference symbol as └n·2^{μ}DL/2^{μ}UL┘, where n is the uplink symbol related to the PRACH occasion, μ_{DL} is a downlink subcarrier spacing, and μ_{UL} in is an uplink subcarrier spacing. In another embodiment, reference symbol is a downlink symbol having a same frame number, slot number, and symbol number as a last uplink symbol of the PRACH occasion in which the first random access transmission was transmitted.

As also described above, in one embodiment, the start of the response window is a start of a first PDCCH monitoring occasion occurring at least one symbol after the reference symbol. In one embodiment, there is at least one symbol gap between the reference symbol and the start of the response window. In another embodiment, the start of the response window is a symbol occurring immediately after the reference symbol. In another embodiment, a minimum symbol gap between the reference symbol and the start of the response window is configurable. In one embodiment, a minimum symbol gap between the reference symbol and the start of the response window is a function of symbol duration. In one embodiment, a minimum symbol gap between the reference symbol and the start of the response window is a function of subcarrier spacing. In some embodiments, the start of the response window is aligned with a start of a PDCCH monitoring occasion. In some other embodiments, the start of the response window independent of PDCCH monitoring occasions.

As discussed above, in one embodiment, the UE 712 uses a TA estimate when transmitting the first random access transmission. By doing so, it can be assumed that the last symbol of the RACH occasion in which the random access preamble was transmitted by the UE 712 in step 1100 arrives at the base station 802 at or near the same time that the downlink symbol that is determined by the UE 712 in step 1102 to be the reference symbol is transmitted at the base station 802. In this manner, the reference symbol becomes a particularly well-suited reference symbol for the start of the response window at the UE 712 (e.g., because the RAR or MsgB cannot be transmitted by the base station 802 before completing reception of the first random access transmission). However, the use of such a TA estimate for transmission of the first random access transmission in step 1100 is not required.

The UE 712 monitors for a response during the response window, where the start of the response window is defined relative to the reference symbol (step 1104). The random access procedure may then continue, e.g., in the conventional manner.

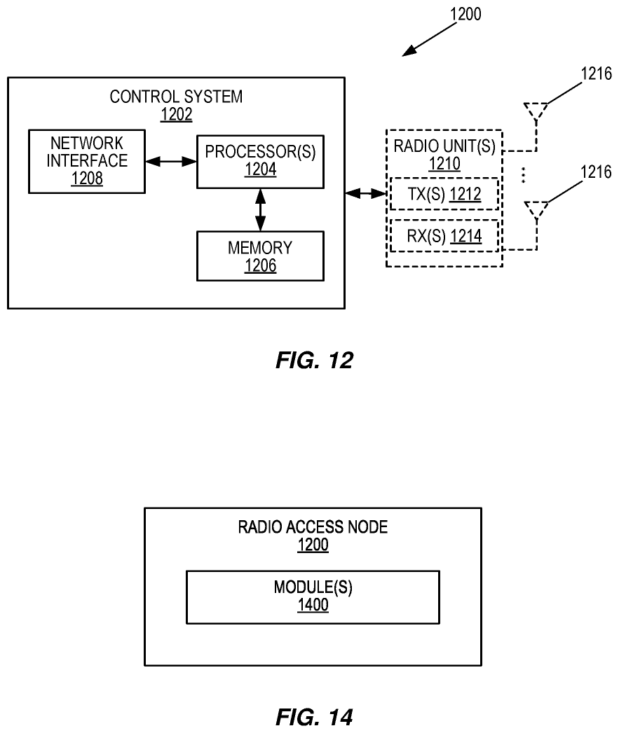

FIG. 12 is a schematic block diagram of a radio access node 1200 according to some embodiments of the present disclosure. Optional features are represented by dashed boxes. The radio access node 1200 may be, for example, a base station 702 or 706 or a network node that implements all or part of the functionality of the base station 702 or gNB described herein. As illustrated, the radio access node 1200 includes a control system 1202 that includes one or more processors 1204 (e.g., Central Processing Units (CPUs), Application Specific Integrated Circuits (ASICs), Field Programmable Gate Arrays (FPGAs), and/or the like), memory 1206, and a network interface 1208. The one or more processors 1204 are also referred to herein as processing circuitry. In addition, the radio access node 1200 may include one or more radio units 1210 that each includes one or more transmitters 1212 and one or more receivers 1214 coupled to one or more antennas 1216. The radio units 1210 may be referred to or be part of radio interface circuitry. In some embodiments, the radio unit(s) 1210 is external to the control system 1202 and connected to the control system 1202 via, e.g., a wired connection (e.g., an optical cable). However, in some other embodiments, the radio unit(s) 1210 and potentially the antenna(s) 1216 are integrated together with the control system 1202. The one or more processors 1204 operate to provide one or more functions of a radio access node 1200 as described herein. In some embodiments, the function(s) are implemented in software that is stored, e.g., in the memory 1206 and executed by the one or more processors 1204.

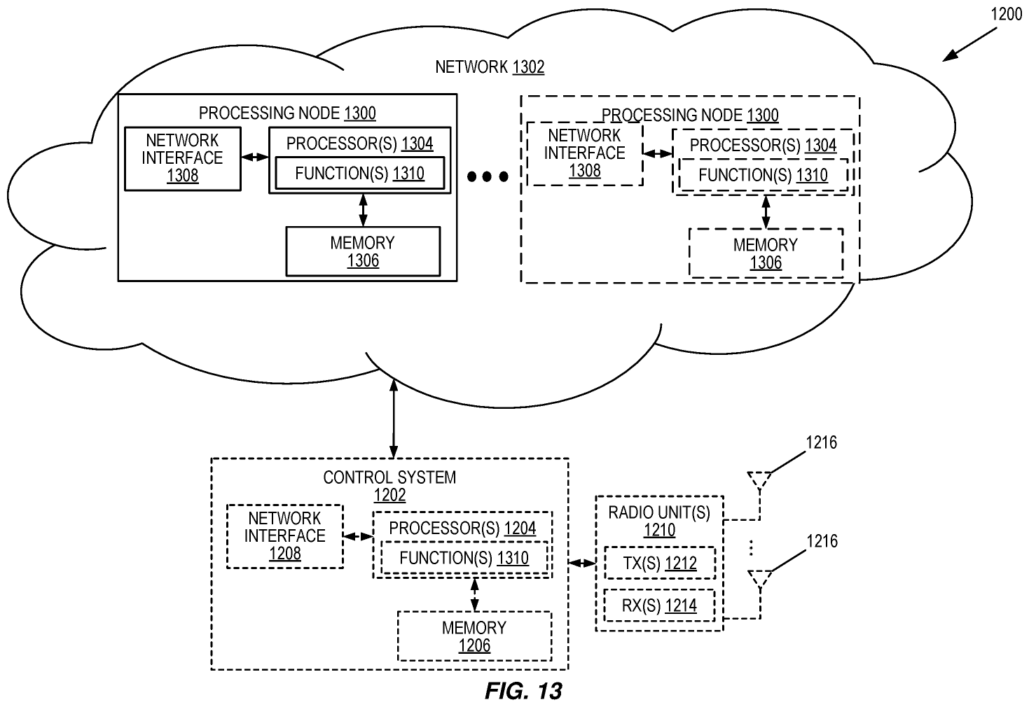

FIG. 13 is a schematic block diagram that illustrates a virtualized embodiment of the radio access node 1200 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1200 in which at least a portion of the functionality of the radio access node 1200 is implemented as a virtual component(s) (e.g., via a virtual machine(s) executing on a physical processing node(s) in a network(s)). As illustrated, in this example, the radio access node 1200 may include the control system 1202 and/or the one or more radio units 1210, as described above. The control system 1202 may be connected to the radio unit(s) 1210 via, for example, an optical cable or the like. The radio access node 1200 includes one or more processing nodes 1300 coupled to or included as part of a network(s) 1302. If present, the control system 1202 or the radio unit(s) are connected to the processing node(s) 1300 via the network 1302. Each processing node 1300 includes one or more processors 1304 (e.g., CPUs, ASICs, FPGAs, and/or the like), memory 1306, and a network interface 1308.

In this example, functions 1310 of the radio access node 1200 described herein are implemented at the one or more processing nodes 1300 or distributed across the one or more processing nodes 1300 and the control system 1202 and/or the radio unit(s) 1210 in any desired manner. In some particular embodiments, some or all of the functions 1310 of the radio access node 1200 described herein are implemented as virtual components executed by one or more virtual machines implemented in a virtual environment(s) hosted by the processing node(s) 1300. As will be appreciated by one of ordinary skill in the art, additional signaling or communication between the processing node(s) 1300 and the control system 1202 is used in order to carry out at least some of the desired functions 1310. Notably, in some embodiments, the control system 1202 may not be included, in which case the radio unit(s) 1210 communicate directly with the processing node(s) 1300 via an appropriate network interface(s).

In some embodiments, a computer program including instructions which, when executed by at least one processor, causes the at least one processor to carry out the functionality of radio access node 1200 or a node (e.g., a processing node 1300) implementing one or more of the functions 1310 of the radio access node 1200 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 14 is a schematic block diagram of the radio access node 1200 according to some other embodiments of the present disclosure. The radio access node 1200 includes one or more modules 1400, each of which is implemented in software. The module(s) 1400 provide the functionality of the radio access node 1200 described herein. This discussion is equally applicable to the processing node 1300 of FIG. 13 where the modules 1400 may be implemented at one of the processing nodes 1300 or distributed across multiple processing nodes 1300 and/or distributed across the processing node(s) 1300 and the control system 1202.

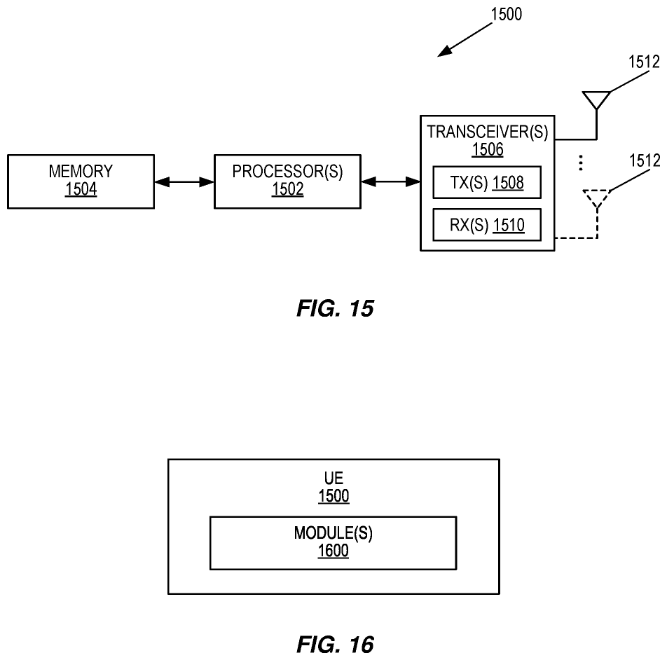

FIG. 15 is a schematic block diagram of a wireless communication device 1500 according to some embodiments of the present disclosure. The wireless communication device 1500 may be, for example, the UE 712. As illustrated, the wireless communication device 1500 includes one or more processors 1502 (e.g., CPUs, ASICs, FPGAs, and/or the like), memory 1504, and one or more transceivers 1506 each including one or more transmitters 1508 and one or more receivers 1510 coupled to one or more antennas 1512. The transceiver(s) 1506 includes radio-front end circuitry connected to the antenna(s) 1512 that is configured to condition signals communicated between the antenna(s) 1512 and the processor(s) 1502, as will be appreciated by on of ordinary skill in the art. The processors 1502 are also referred to herein as processing circuitry. The transceivers 1506 are also referred to herein as radio circuitry. In some embodiments, the functionality of the wireless communication device 1500 described above (e.g., the functionality of a UE such as UE 712 described above) may be fully or partially implemented in software that is, e.g., stored in the memory 1504 and executed by the processor(s) 1502. Note that the wireless communication device 1500 may include additional components not illustrated in FIG. 15 such as, e.g., one or more user interface components (e.g., an input/output interface including a display, buttons, a touch screen, a microphone, a speaker(s), and/or the like and/or any other components for allowing input of information into the wireless communication device 1500 and/or allowing output of information from the wireless communication device 1500), a power supply (e.g., a battery and associated power circuitry), etc.

In some embodiments, a computer program including instructions which, when executed by at least one processor, causes the at least one processor to carry out the functionality of the wireless communication device 1500 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 16 is a schematic block diagram of the wireless communication device 1500 according to some other embodiments of the present disclosure. The wireless communication device 1500 includes one or more modules 1600, each of which is implemented in software. The module(s) 1600 provide the functionality of the wireless communication device 1500 described herein (e.g., the functionality of a UE such as UE 712 described above).

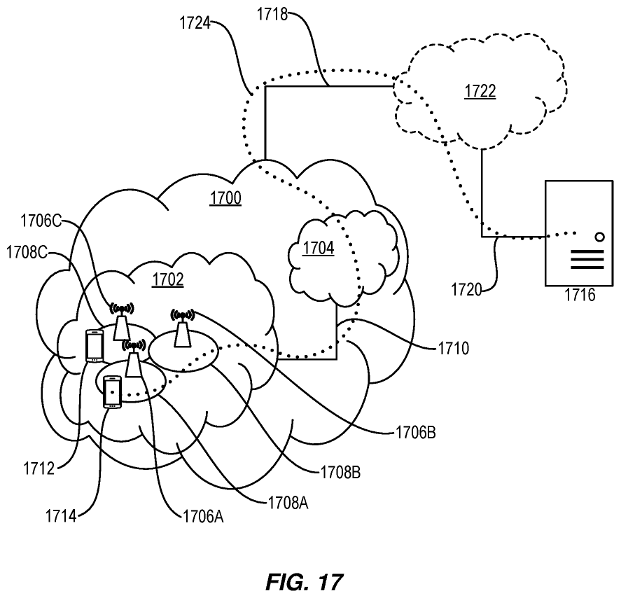

With reference to FIG. 17, in accordance with an embodiment, a communication system includes a telecommunication network 1700, such as a 3GPP-type cellular network, which comprises an access network 1702, such as a RAN, and a core network 1704. The access network 1702 comprises a plurality of base stations 1706A, 1706B, 1706C, such as Node Bs, eNBs, gNBs, or other types of wireless Access Points (APs), each defining a corresponding coverage area 1708A, 1708B, 1708C. Each base station 1706A, 1706B, 1706C is connectable to the core network 1704 over a wired or wireless connection 1710. A first UE 1712 located in coverage area 1708C is configured to wirelessly connect to, or be paged by, the corresponding base station 1706C. A second UE 1714 in coverage area 1708A is wirelessly connectable to the corresponding base station 1706A. While a plurality of UEs 1712, 1714 are illustrated in this example, the disclosed embodiments are equally applicable to a situation where a sole UE is in the coverage area or where a sole UE is connecting to the corresponding base station 1706.

The telecommunication network 1700 is itself connected to a host computer 1716, which may be embodied in the hardware and/or software of a standalone server, a cloud-implemented server, a distributed server, or as processing resources in a server farm. The host computer 1716 may be under the ownership or control of a service provider, or may be operated by the service provider or on behalf of the service provider. Connections 1718 and 1720 between the telecommunication network 1700 and the host computer 1716 may extend directly from the core network 1704 to the host computer 1716 or may go via an optional intermediate network 1722. The intermediate network 1722 may be one of, or a combination of more than one of, a public, private, or hosted network; the intermediate network 1722, if any, may be a backbone network or the Internet; in particular, the intermediate network 1722 may comprise two or more sub-networks (not shown).

The communication system of FIG. 17 as a whole enables connectivity between the connected UEs 1712, 1714 and the host computer 1716. The connectivity may be described as an Over-the-Top (OTT) connection 1724. The host computer 1716 and the connected UEs 1712, 1714 are configured to communicate data and/or signaling via the OTT connection 1724, using the access network 1702, the core network 1704, any intermediate network 1722, and possible further infrastructure (not shown) as intermediaries. The OTT connection 1724 may be transparent in the sense that the participating communication devices through which the OTT connection 1724 passes are unaware of routing of uplink and downlink communications. For example, the base station 1706 may not or need not be informed about the past routing of an incoming downlink communication with data originating from the host computer 1716 to be forwarded (e.g., handed over) to a connected UE 1712. Similarly, the base station 1706 need not be aware of the future routing of an outgoing uplink communication originating from the UE 1712 towards the host computer 1716.

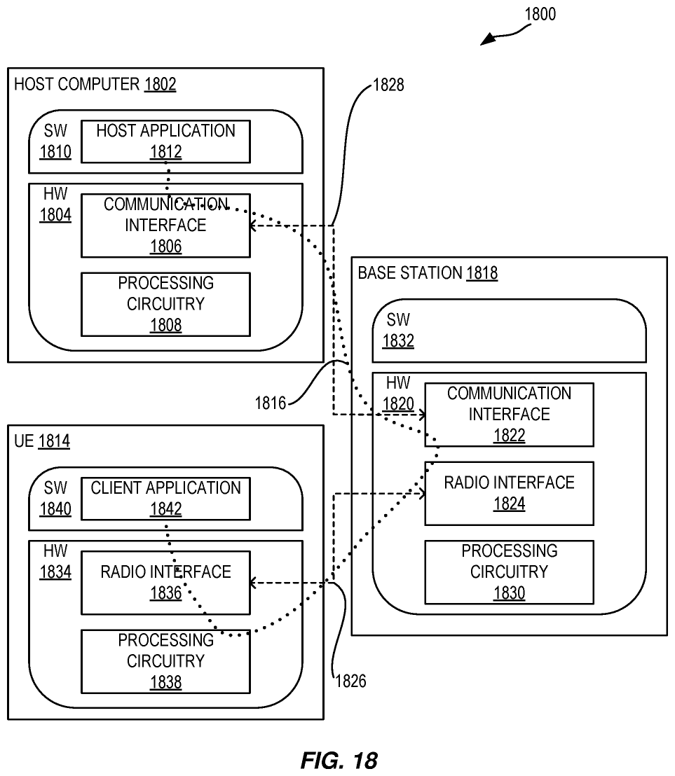

Example implementations, in accordance with an embodiment, of the UE, base station, and host computer discussed in the preceding paragraphs will now be described with reference to FIG. 18. In a communication system 1800, a host computer 1802 comprises hardware 1804 including a communication interface 1806 configured to set up and maintain a wired or wireless connection with an interface of a different communication device of the communication system 1800. The host computer 1802 further comprises processing circuitry 1808, which may have storage and/or processing capabilities. In particular, the processing circuitry 1808 may comprise one or more programmable processors, ASICs, FPGAs, or combinations of these (not shown) adapted to execute instructions. The host computer 1802 further comprises software 1810, which is stored in or accessible by the host computer 1802 and executable by the processing circuitry 1808. The software 1810 includes a host application 1812. The host application 1812 may be operable to provide a service to a remote user, such as a UE 1814 connecting via an OTT connection 1816 terminating at the UE 1814 and the host computer 1802. In providing the service to the remote user, the host application 1812 may provide user data which is transmitted using the OTT connection 1816.

The communication system 1800 further includes a base station 1818 provided in a telecommunication system and comprising hardware 1820 enabling it to communicate with the host computer 1802 and with the UE 1814. The hardware 1820 may include a communication interface 1822 for setting up and maintaining a wired or wireless connection with an interface of a different communication device of the communication system 1800, as well as a radio interface 1824 for setting up and maintaining at least a wireless connection 1826 with the UE 1814 located in a coverage area (not shown in FIG. 18) served by the base station 1818. The communication interface 1822 may be configured to facilitate a connection 1828 to the host computer 1802. The connection 1828 may be direct or it may pass through a core network (not shown in FIG. 18) of the telecommunication system and/or through one or more intermediate networks outside the telecommunication system. In the embodiment shown, the hardware 1820 of the base station 1818 further includes processing circuitry 1830, which may comprise one or more programmable processors, ASICs, FPGAs, or combinations of these (not shown) adapted to execute instructions. The base station 1818 further has software 1832 stored internally or accessible via an external connection.

The communication system 1800 further includes the UE 1814 already referred to. The UE's 1814 hardware 1834 may include a radio interface 1836 configured to set up and maintain a wireless connection 1826 with a base station serving a coverage area in which the UE 1814 is currently located. The hardware 1834 of the UE 1814 further includes processing circuitry 1838, which may comprise one or more programmable processors, ASICs, FPGAs, or combinations of these (not shown) adapted to execute instructions. The UE 1814 further comprises software 1840, which is stored in or accessible by the UE 1814 and executable by the processing circuitry 1838. The software 1840 includes a client application 1842. The client application 1842 may be operable to provide a service to a human or non-human user via the UE 1814, with the support of the host computer 1802. In the host computer 1802, the executing host application 1812 may communicate with the executing client application 1842 via the OTT connection 1816 terminating at the UE 1814 and the host computer 1802. In providing the service to the user, the client application 1842 may receive request data from the host application 1812 and provide user data in response to the request data. The OTT connection 1816 may transfer both the request data and the user data. The client application 1842 may interact with the user to generate the user data that it provides.

It is noted that the host computer 1802, the base station 1818, and the UE 1814 illustrated in FIG. 18 may be similar or identical to the host computer 1716, one of the base stations 1706A, 1706B, 1706C, and one of the UEs 1712, 1714 of FIG. 17, respectively. This is to say, the inner workings of these entities may be as shown in FIG. 18 and independently, the surrounding network topology may be that of FIG. 17.

In FIG. 18, the OTT connection 1816 has been drawn abstractly to illustrate the communication between the host computer 1802 and the UE 1814 via the base station 1818 without explicit reference to any intermediary devices and the precise routing of messages via these devices. The network infrastructure may determine the routing, which may be configured to hide from the UE 1814 or from the service provider operating the host computer 1802, or both. While the OTT connection 1816 is active, the network infrastructure may further take decisions by which it dynamically changes the routing (e.g., on the basis of load balancing consideration or reconfiguration of the network).

The wireless connection 1826 between the UE 1814 and the base station 1818 is in accordance with the teachings of the embodiments described throughout this disclosure. One or more of the various embodiments improve the performance of OTT services provided to the UE 1814 using the OTT connection 1816, in which the wireless connection 1826 forms the last segment.

A measurement procedure may be provided for the purpose of monitoring data rate, latency, and other factors on which the one or more embodiments improve. There may further be an optional network functionality for reconfiguring the OTT connection 1816 between the host computer 1802 and the UE 1814, in response to variations in the measurement results. The measurement procedure and/or the network functionality for reconfiguring the OTT connection 1816 may be implemented in the software 1810 and the hardware 1804 of the host computer 1802 or in the software 1840 and the hardware 1834 of the UE 1814, or both. In some embodiments, sensors (not shown) may be deployed in or in association with communication devices through which the OTT connection 1816 passes; the sensors may participate in the measurement procedure by supplying values of the monitored quantities exemplified above, or supplying values of other physical quantities from which the software 1810, 1840 may compute or estimate the monitored quantities. The reconfiguring of the OTT connection 1816 may include message format, retransmission settings, preferred routing, etc.; the reconfiguring need not affect the base station 1818, and it may be unknown or imperceptible to the base station 1818. Such procedures and functionalities may be known and practiced in the art. In certain embodiments, measurements may involve proprietary UE signaling facilitating the host computer 1802's measurements of throughput, propagation times, latency, and the like. The measurements may be implemented in that the software 1810 and 1840 causes messages to be transmitted, in particular empty or ‘dummy’ messages, using the OTT connection 1816 while it monitors propagation times, errors, etc.

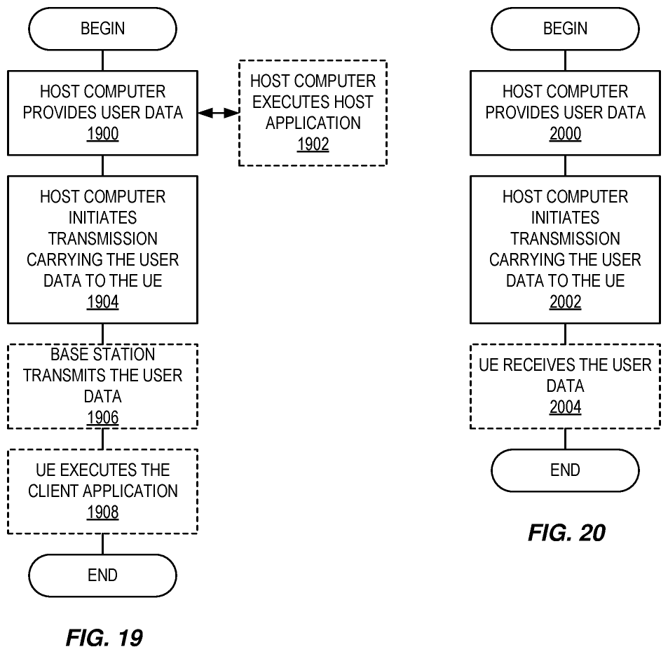

FIG. 19 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 19 will be included in this section. In step 1900, the host computer provides user data. In sub-step 1902 (which may be optional) of step 1900, the host computer provides the user data by executing a host application. In step 1904, the host computer initiates a transmission carrying the user data to the UE. In step 1906 (which may be optional), the base station transmits to the UE the user data which was carried in the transmission that the host computer initiated, in accordance with the teachings of the embodiments described throughout this disclosure. In step 1908 (which may also be optional), the UE executes a client application associated with the host application executed by the host computer.

FIG. 20 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 20 will be included in this section. In step 2000 of the method, the host computer provides user data. In an optional sub-step (not shown) the host computer provides the user data by executing a host application. In step 2002, the host computer initiates a transmission carrying the user data to the UE. The transmission may pass via the base station, in accordance with the teachings of the embodiments described throughout this disclosure. In step 2004 (which may be optional), the UE receives the user data carried in the transmission.

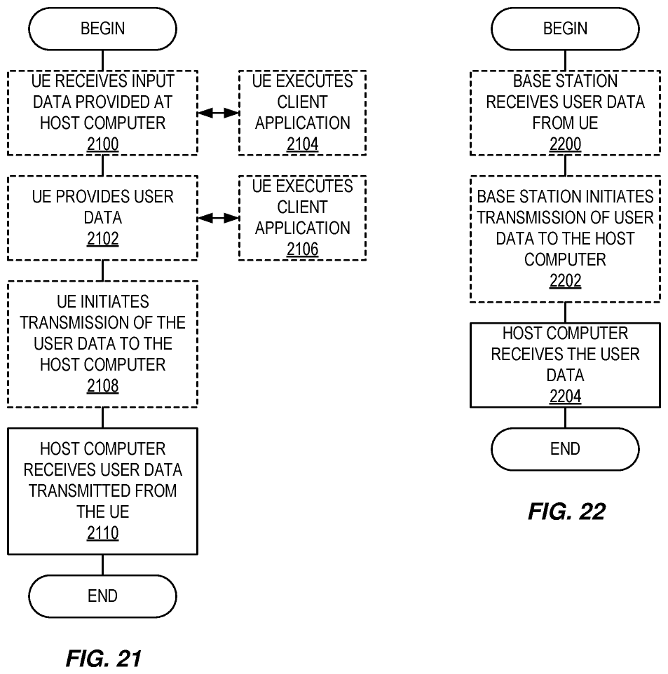

FIG. 21 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 21 will be included in this section. In step 2100 (which may be optional), the UE receives input data provided by the host computer. Additionally or alternatively, in step 2102, the UE provides user data. In sub-step 2104 (which may be optional) of step 2100, the UE provides the user data by executing a client application. In sub-step 2106 (which may be optional) of step 2102, the UE executes a client application which provides the user data in reaction to the received input data provided by the host computer. In providing the user data, the executed client application may further consider user input received from the user. Regardless of the specific manner in which the user data was provided, the UE initiates, in sub-step 2108 (which may be optional), transmission of the user data to the host computer. In step 2110 of the method, the host computer receives the user data transmitted from the UE, in accordance with the teachings of the embodiments described throughout this disclosure.

FIG. 22 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 22 will be included in this section. In step 2200 (which may be optional), in accordance with the teachings of the embodiments described throughout this disclosure, the base station receives user data from the UE. In step 2202 (which may be optional), the base station initiates transmission of the received user data to the host computer. In step 2204 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Management Function
AN Access Network
AP Access Point
ASIC Application Specific Integrated Circuit
AUSF Authentication Server Function
BWP Bandwidth Part
CBRA Contention-Based Random Access
CE Control Element
CFRA Contention-Free Random Access
CMAS Commercial Mobile Alert System
CP Cyclic Prefix
CPU Central Processing Unit
C-RNTI Cell Radio Network Temporary Identifier
CRS Cell Specific Reference Signal
DCI Downlink Control Information
DL Downlink
DMRS DeModulation Reference Signal
DN Data Network
DSP Digital Signal Processor
eNB Enhanced or Evolved Node B
ETWS Earthquake and Tsunami Warning System
FDM Frequency Division Multiplexed
FPGA Field Programmable Gate Array
FR Frequency Range
GEO Geostationary Earth Orbit
gNB New Radio Base Station
gNB-CU New Radio Base Station Central Unit
gNB-DU New Radio Base Station Distributed Unit
GNSS Global Navigation Satellite System
HARQ Hybrid Automatic Repeat Request
HSS Home Subscriber Server
IoT Internet of Things
I-RNTI Inactive Radio Network Temporary Identifier
LEO Low Earth Orbit
LTE Long Term Evolution
MAC Medium Access Control
MEO Medium Earth Orbit
MIB Master Information Block
MME Mobility Management Entity
msgA Message A
msgB Message B
MSI Minimum System Information
MTC Machine Type Communication
NEF Network Exposure Function
NF Network Function
NG-RAN Next Generation Radio Access Network
NR New Radio
NRF Network Function Repository Function
NR-MIB New Radio Master Information Block
NSSF Network Slice Selection Function
NTN Non-Terrestrial Network
OFDM Orthogonal Frequency-Division Multiplexing
OSI Other System Information
OTT Over-the-Top
PBCH Public Broadcast Channel
PC Personal Computer
PCF Policy Control Function
PCI Physical Cell Identity
PDCCH Physical Downlink Control Channel
PDSCH Physical Downlink Shared Channel
PDU Protocol Data Unit
P-GW Packet Data Network Gateway
PO Physical Uplink Shared Channel Occasion
PRACH Physical Random Access Channel
PSS Primary Synchronization Signal
PUCCH Physical Uplink Control Channel
PUSCH Physical Uplink Shared Channel
QCL Quasi Co-Located
RA Random Access
RACH Random Access Channel
RAM Random Access Memory
RAN Radio Access Network
RAPID Random Access Preamble Identity
RAR Random Access Response
RMSI Remaining Minimum System Information
RNTI Radio Network Temporary Identifier
RO Random Access Channel Occasion
ROM Read Only Memory
RRC Radio Resource Control
RRH Remote Radio Head
RS Reference Signal
RTT Round Trip Time
RU Resource Unit
SCEF Service Capability Exposure Function
SCS Subcarrier Spacings
SFN System Frame Number
SI System Information
SIB1 System Information Block Type 1
SMF Session Management Function
SS Synchronization Signal
SSB Synchronization Signal Block
SSS Secondary Synchronization Signal
TA Timing Advance
TDD Time Division Duplexing
TMSI Temporary Mobile Subscriber Identity
TRP Transmission/Reception Point
TSG-RAN Technical Specification Group Radio Access Network
UDM Unified Data Management
UE User Equipment
UL Uplink
UPF User Plane Function

Those skilled in the art will recognize improvements and modifications to the embodiments of the present disclosure. All such improvements and modifications are considered within the scope of the concepts disclosed herein.

1. A method performed by a User Equipment, UE, for random access to a Radio Access Network, RAN, of a cellular communications system, the method comprising:
transmitting a first random access transmission in a Physical Random Access Channel, PRACH, occasion, the first random access transmission being either a random access preamble or a MsgA;
determining a reference symbol for a start of a response window, the response window being either a Random Access Response, RAR, window or a MsgB response window; and
monitoring for a response during the response window, the start of the response window being defined relative to the reference symbol.

2. The method of claim 1 wherein determining the reference symbol comprises determining the reference symbol based on an uplink symbol related to the PRACH occasion in which a first random access response transmission was transmitted.

3. The method of claim 2 wherein the uplink symbol related to the PRACH occasion in which the first random access response transmission was transmitted is a last uplink symbol of the PRACH occasion in which the first random access response transmission was transmitted.

4. The method of claim 2 wherein determining the reference symbol comprises determining the reference symbol based on an assumed timing advance of zero.

5. The method of claim 2 wherein determining the reference symbol comprises determining the reference symbol as └n·2^{μ}DL/2^{μ}UL┘, where n is the uplink symbol related to the PRACH occasion, μ_{DL} is a downlink subcarrier spacing, and μ_{UL} is an uplink subcarrier spacing.

6. The method of claim 2 wherein the reference symbol is a downlink symbol having a same frame number, slot number, and symbol number as a last uplink symbol of the PRACH occasion in which the first random access transmission was transmitted.

7. The method of claim 1 wherein the reference symbol is a downlink symbol having a same frame number, slot number, and symbol number as a last uplink symbol of the PRACH occasion in which the first random access transmission was transmitted.

8. The method of claim 7 wherein determining the reference symbol comprises determining the reference symbol based on an assumed timing advance of zero.

9. The method of claim 1 wherein uplink and downlink in the RAN share a common timing structure.

10. The method of claim 1 wherein the RAN comprises a Non-Terrestrial Network, NTN.

11. The method of claim 1 wherein a cell to which the UE is performing random access is a cell served by a non-terrestrial base station.

12. The method of claim 1 wherein the start of the response window is a start of a first Physical Downlink Control Channel, PDCCH, monitoring occasion occurring at least one symbol after the reference symbol.

13. The method of claim 1 wherein there is at least one symbol gap between the reference symbol and the start of the response window.

14. The method of claim 1 wherein the start of the response window is a symbol occurring immediately after the reference symbol.

15. The method of claim 1 wherein a minimum symbol gap between the reference symbol and the start of the response window is configurable.

16. The method of claim 1 wherein a minimum symbol gap between the reference symbol and the start of the response window is a function of symbol duration.

17. The method of claim 1 wherein a minimum symbol gap between the reference symbol and the start of the response window is a function of subcarrier spacing.

18. The method of claim 1 wherein the start of the response window is aligned with a start of a PDCCH monitoring occasion.

19. The method of claim 1 wherein the start of the response window is independent of PDCCH monitoring occasions.

20. (canceled)

21. (canceled)

22. A wireless communication device comprising:
one or more transmitters;
one or more receivers; and
processing circuitry associated with the one or more transmitters and the one or more receivers, the processing circuitry configured to cause the wireless communication device to:
transmit a first random access transmission in a Physical Random Access Channel, PRACH, occasion, the first random access transmission being either a random access preamble or a MsgA;
determine a reference symbol for a start of a response window, the response window being either a Random Access Response, RAR, window or a MsgB response window; and
monitor for a response during the response window, the start of the response window being defined relative to the reference symbol.

23. (canceled)
